(19) United States
(12) Patent Application Publication
(10) Pub. No.: US 2014/0042089 A1
(43) Pub. Date: Feb. 13, 2014

(54) DESALINATION TREATMENT MEMBRANE, DESALINATION TREATMENT METHOD, AND DESALINATION TREATMENT APPARATUS

(71) Applicant: KABUSHIKI KAISHA TOSHIBA, Minato-ku (JP)

(72) Inventors: Akihiro MATSUI, Singapore (SG); Kenji Sano, Tokyo (JP); Hideyuki Tsuji, Yokohama-shi (JP); Arisa Yamada, Kawasaki-shi (JP)

(73) Assignee: KABUSHIKI KAISHA TOSHIBA, Minato-ku (JP)

(21) Appl. No.: 13/963,412

(22) Filed: Aug. 9, 2013

(30) Foreign Application Priority Data
Aug. 10, 2012 (JP) 2012-178961

(51) Int. Cl. B01D 71/60; B01D 71/12; B01D 67/00

(52) U.S. Cl. CPC B01D 71/60; B01D 67/0006; B01D 71/12
USPC 210/638; 210/490; 210/321.72

(57) ABSTRACT

According to one embodiment, a desalination treatment membrane includes a desalting membrane and a base material disposed in close contact with the desalting membrane, the base material being subjected to a silane coupling treatment.

### CROSS-REFERENCE TO RELATED APPLICATIONS

This application is based upon and claims the benefit of priority from Japanese Patent Application No. 2012-178961, filed Aug. 10, 2012, the entire contents of which are incorporated herein by reference.

### FIELD

Embodiments described herein relate generally to a desalination treatment membrane for desalination of salt water such as seawater, a desalination treatment method, and a desalination treatment apparatus.

### BACKGROUND

Reverse osmosis membrane (RO membrane) methods have hitherto been widely used in a desalination method of seawater. A reverse osmosis desalination method (RO method) is a method in which a pressure of about 55 atmospheres is applied to an osmosis membrane in an opposite direction of the osmotic pressure, thereby taking out fresh water from about 3.5% by weight seawater.

It is known that when a polymer electrolyte membrane obtained by a direct graft-polymerization of an electrolyte monomer to a hydrophobic polymer membrane is utilized in the RO method, a transmembrane flow rate is increased.

On the other hand, a forward osmosis membrane seawater desalination method (FO method) is known as the desalination method. According to this method, an osmosis membrane, which is the same as that used in the RO method, is used, and an aqueous ammonium carbonate having a higher concentration than that of seawater is disposed at a support membrane side, whereby fresh water is drawn into the aqueous ammonium carbonate side due to an osmotic pressure caused by ammonium carbonate, without applying a pressure. After that, the temperature of the ammonium carbonate solution is elevated to about 60° C. by heating it to decompose it into carbonic acid and ammonia, from which water is removed, thus resulting in acquisition of fresh water.

Further, there is also a composite semipermeable membrane having an ionic group or non-ionic group.

### BRIEF DESCRIPTION OF THE DRAWINGS

FIG. 1 is a view showing an example of a desalination treatment membrane of an embodiment;

FIG. 2 is a view showing an example of a desalination treatment apparatus of an embodiment;

FIG. 3 is a view showing an example of a desalination treatment membrane of an embodiment;

FIG. 4 is a view showing an example of a desalination treatment apparatus of an embodiment;

FIG. 5 is a view showing an example of a desalination treatment membrane of an embodiment;

FIG. 6 is a view showing an example of a desalination treatment apparatus of an embodiment;

FIG. 7 is a view showing an example of a desalination treatment membrane of an embodiment;

FIG. 8 is a view showing an example of a desalination treatment apparatus of an embodiment;

FIG. 9 is a view showing a formation of a syringe test apparatus;

FIG. 10 is a view showing a syringe test apparatus;

FIG. 11 is a view showing a high pressure test apparatus;

FIG. 12 is a view showing a syringe test apparatus;

FIG. 13 is a graph showing results of a syringe test;

FIG. 14 is a view showing an example of a desalination treatment membrane of an embodiment; and

FIG. 15 is view showing an example of a desalination treatment apparatus of an embodiment.

### DETAILED DESCRIPTION

In general, according to one embodiment, when a functional group is disposed in the vicinity of a desalting membrane, it is possible to cause an osmotic pressure toward a desalination treatment membrane including the desalting membrane. When it is utilized, it is possible to obtain fresh water from seawater in a flow rate higher than that obtained in conventional methods.

The functional group may be disposed in the vicinity of the desalting membrane by, for example, closely bringing a base material to which the functional groups are bonded (i.e., a “modified base material”) into contact with the desalting membrane, or directly bonding the functional groups to the desalting membrane.

The embodiments provide, for example, a desalination treatment membrane comprising a desalting membrane, and a base material which is disposed in close contact with the desalting membrane and which is subjected to a silane coupling treatment.

The embodiments provide a desalination treatment membrane capable of performing desalination of seawater using lower energy, and a desalination treatment method and a desalination treatment apparatus using the membrane.

### First Embodiment

A desalination treatment membrane and a desalination treatment method according to a first embodiment are explained below.

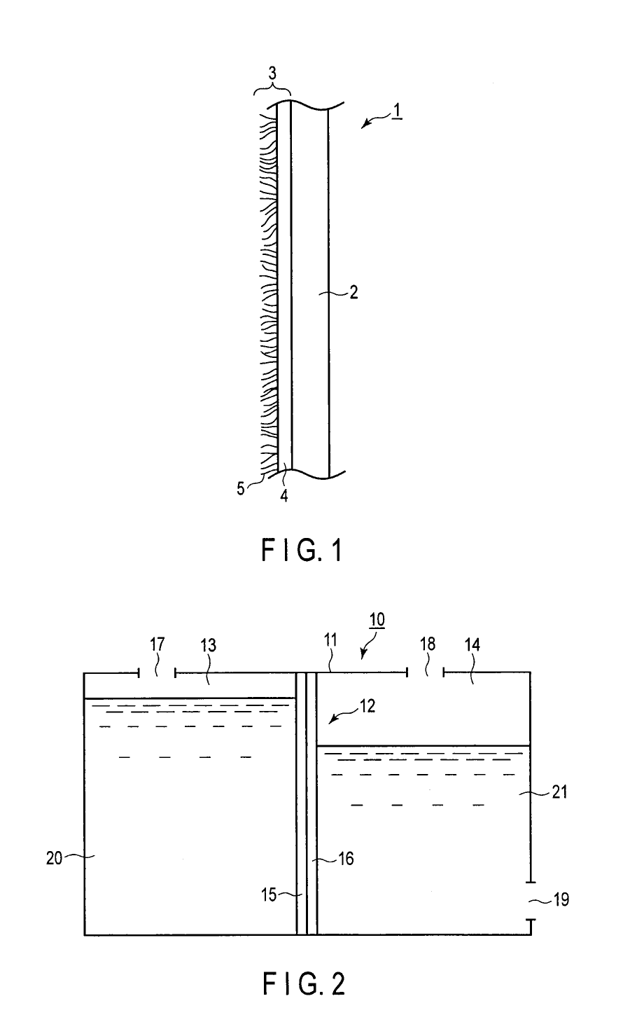

The desalination treatment membrane according to the embodiment comprises a desalting membrane, and a base material disposed in close contact therewith. The base material is a modified base material which is subjected to a silane coupling treatment. Using FIG. 1, this is further explained.

A desalination treatment membrane 1 comprises a desalting membrane 2, and a modified base material 3. The modified base material 3 is disposed in close contact with this desalting membrane 2, and is subjected to a silane coupling treatment. The modified base material 3 comprises a base material 4 and functional groups 5. The functional group 5 is a group derived from a silane coupling agent, and is introduced to a surface of the base material 4, opposite to a surface brought into contact with the desalting membrane 2.

When salt water is subjected to a desalination treatment using such a desalination treatment membrane, water (fresh water) can be taken out from salt water. In a desalination treatment method, the desalination treatment membrane is disposed so that the desalination treatment membrane is brought into contact with the salt water on the desalting membrane 2 side, and with the fresh water on the base material 4 side; in other words, the desalting membrane in the desalination treatment membrane is disposed on the salt water side and the base material is disposed on the fresh water side.

According to a conventional forward osmotic pressure seawater desalination method, basically, fresh water is absorbed from seawater and recovered. For that reason, a solution having a higher salt concentration than that of seawater, and seawater are disposed so that they are respectively brought into contact with the two surfaces of the osmosis membrane, thereby inducing an osmotic pressure necessary for permeation of water in the seawater through the osmosis membrane to force the water into the solution having a higher salt concentration. Ammonium chloride is used as the salt.

Ammonium chloride has a high solubility in water, and is decomposed into ammonia and carbon dioxide at 60° C. into gases. Thus, the remaining water is fresh water.

According to the embodiment, instead of the solution having a higher salt concentration described above, the modified base material, which is subjected to the silane coupling treatment, is disposed in close contact with the desalting membrane. In a method of performing desalination treatment using the desalination treatment membrane in which the modified base material is disposed in close contact with the desalting membrane, the desalting membrane is disposed on the seawater side, and the modified base material is disposed on the fresh water side. The functional groups, which are derived from the silane coupling agent and introduced into the modified base material, have a function of inducing an osmotic pressure necessary for permeation of water in seawater through the desalting membrane. In other words, the functional groups, which are derived from the silane coupling agent and introduced into the modified base material, can cause an osmotic pressure, which is directed toward the fresh water side of the desalting membrane from the seawater side thereof. In addition, the introduced functional groups swell with water which has permeated the desalting membrane, but are not dissolved in the water within a given temperature range. Furthermore, the functional groups are bonded to the modified base material. For those reasons, the functional groups are not separated from the base material, and remain stably on the base material surface. As a result, the water, which has permeated the desalting membrane, moves stably to the fresh water side through the modified base material, and then is recovered.

According to the conventional method using the ammonium chloride solution having a high salt concentration, operations are required in which water in the seawater is forced to permeate the osmosis membrane and to move into an ammonium chloride solution, and then the solution is heated to 60° C. or higher to release ammonia and carbon dioxide as gases. According to the present embodiment, however, the heating treatment is not required.

In addition, when the same pressure as that used in the RO method which has been conventionally performed is applied, it is possible to more quickly obtain fresh water from salt water at a higher flow rate compared to the conventional RO method. Furthermore, even if a lower pressure is applied, it is possible to obtain fresh water from salt water. It is possible, therefore, to perform the desalination of salt water at lower energy than that in expended the conventional method.

As the desalting membrane 2, a membrane which is utilized as an osmosis membrane, such as a cellulose acetate membrane or a polyamide membrane, may be used. The desalting membrane has preferably a thickness of 45 μm to 250 μm.

As the base material 4, for example, a paper, cotton, a cellulose membrane such as cupra, rayon or copper ammonium rayon, a fabric, or a resin membrane may be used. Of these, a soft paper such as a filter paper and a non-woven fabric, which are capable of preventing damage to the desalting membrane under pressure, are preferable. In order to reduce a pressure loss as much as possible, it is preferable to use a base material having a higher water-permeability. The base material 4 has preferably a thickness of, for example, 1 μm to 100 μm.

The base material 4 may be in the state of single fibers or multiple fibers, or beads. When it is in the state of single fibers or multiple fibers, the fiber may be pieces of the cellulose membrane, fabric or resin membrane, or fibers obtained by disentanglement thereof.

Resin beads may also be used as the base material 4. In this case, the resin used may be, for example, resins capable of introducing the silane coupling agent such as polyvinyl alcohol, cellulose, processed cellulose and polyacrylic acid. The base material 4 which is subjected to the silane coupling treatment is also referred to as the “silane coupling base material”. The resin beads may have a size of 0.01 mm to 2 mm, and may have a size of 1 mm to 5 mm, in terms of the passage of water.

A pressure may be applied to the desalting membrane, or may not be applied. In such a case, the base material 4 formed of the resin beads or fiber disposed may have a size of 0.01 mm to 5 mm, preferably 1 mm to 5 mm.

The base material 4, which is subjected to the silane coupling treatment, may be a base material into which a silane coupling agent is introduced. The silane coupling agent may be, for example, a compound in which a structure having a high compatibility with water is introduced into a substituent formed of carbon directly bonded to silane. The structure having a high compatibility with water are exemplified by —OH, —NH₂, NH—, —N═, —NH₃⁺, —NH₂⁺—, ═N⁺═, and the like.

The silane coupling agent may include, for example, N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, N-(vinylbenzyl)-2-aminoethyl-3-aminopropyltrimethoxysilane, (3-ureidopropyl)trimethoxysilane, (3-ureidopropyl)triethoxysilane, trimethyl[3-(triethoxysilyl)propyl]ammonium chloride, and the like. These may form a salt structure and/or a complex structure with an acid, a base, or another counter ion.

The modified base material 3 which is subjected to the silane coupling treatment may comprise a base material 4 and aminosilane which is carried on the base material 4 in the state of a salt. The base material 4 and the aminosilane in the state of a salt may have H₂NCH₂CH₂NHCH₂CH₂CH₂Si as a part of the structure thereof. For example, a preferable aminosilane may be carried on the base material as a functional group in the state of a salt represented by the following formula (I).

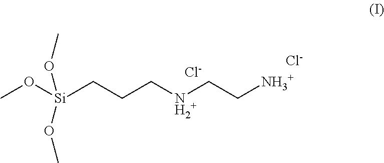

In the functional group in the state of a salt of formula I, the aminosilane is an ammonium cation, and an anion also exists as a counter ion thereof. In water, these counter ions are in a state of being free from each other.

Examples of the preferable aminosilane may include N-2-(aminoethyl)-3-aminopropylmethyldimethoxysilane, and N-2-(aminoethyl)-3-aminopropyltrimethoxysilane. All of these aminosilanes preferably exist in the state of a salt as an ammonium cation. Preferable counter ions to the ammonium cation may include Cl⁻, Br⁻, I⁻, and the like.

The modified base material 3 may be closely brought into contact with the desalting membrane 2 so that the passage of liquid is not inhibited through holes in both of the modified base material 3 and the desalting membrane 2. For example, even if they are only pasted to each other, they are closely brought into contact with each other under a high pressure. In addition, they may be closely brought into contact with each other, for example, by immobilizing them with a support such as a frame, securing them with a net, securing them with another structure, thermofusing the base material and the membrane in their peripheral parts, or bonding the base material and the membrane with an adhesive in their peripheral parts.

When the modified base material 3 is closely brought into contact with the desalting membrane 2, it is preferable to depose the material on an active layer side of the desalting membrane 2. The “active layer” of the desalting membrane 2 refers to a part of the membrane which has an activity of desalting function in a Loeb and Sourirajan type or an asymmetry osmosis membrane 2. The active layer has usually a thickness of 0.1 micron to 1 micron, which is formed on the desalting membrane 2. A part other than the active layer in the desalting membrane 2 refers to a “support layer”. As the direction thereof is opposite to a direction of the RO membrane usually used, it may be disposed in a usual direction if it cannot withstand high pressure in that state.

In the desalination treatment method according to the embodiment, the salt water is, for example, seawater. The salt water to be treated may have a salt concentration of, for example, 0.05% to 4%.

In the embodiment described above, the example has been shown in which the groups derived from the silane coupling agent are introduced as the functional groups 5 on the surface of the base material 4 opposite to the desalting membrane 2 in the modified base material 3. However, the area of the base material to which the functional groups are introduced is not limited thereto. For example, the groups derived from the silane coupling agent may be introduced as the functional groups to the whole base material 4, i.e., an outer surface of the base material to the desalting membrane and/or the inside of the base material.

In the desalination treatment method according to the embodiment, it is preferable to bring fresh water into contact with the modified base material 3 side. When fresh water is brought into contact with the modified base material 3 side, the functional groups which have been introduced into the modified base material 3 swell with fresh water in advance. The functional groups promotes the osmosis of the desalting membrane 2 caused by water in the salt water. As a result, the desalination treatment time can be shortened.

In the desalination treatment method according to the embodiment, a pressure may be applied from the salt water side to the desalination treatment membrane, if necessary.

### Second Embodiment

Next, a desalination treatment apparatus 10 according to a second embodiment is explained referring to FIG. 2.

A hollow rectangular sealing treatment vessel 11 is a horizontal type. The vessel is, for example, divided into a first chamber 13 and a second chamber 14 by a desalination treatment membrane 12. The first and the second chambers 13 and 14 are adjacent each other to a horizontal direction. The desalination treatment membrane 12 is formed of a desalting membrane 15 and a modified base material 16 which is disposed in close contact with this desalting membrane 15. As the base material, for example, a filter paper is used. A first inlet 17 is provided on an upper part of the treatment vessel 11 at which the first chamber 13 is located. A second inlet 18 is provided on an upper part of the treatment vessel 11 at which the second chamber 14 is located. An outlet 19 is provided on a side surface of the treatment vessel 11 at which the second chamber 14 is located. Salt water 20 is received in the first chamber 13 passed through the first inlet 17. Fresh water 21 is received in the second chamber 14 passed through the second inlet 18. The desalting membrane 15 in the desalination treatment membrane 12 is disposed on the side of the first chamber 13 in which the salt water 20 is received, and the modified base material 16 is disposed on the side of the second chamber 14 in which the fresh water 21 is received.

In the desalination treatment apparatus 10, the desalting membrane 15 and the modified base material 16 are disposed, respectively, on the seawater 20 side and the fresh water 21 side. At this time, functional groups introduced from a silane coupling agent into a base material (such as a filter paper) of the modified base material 16 have an action of inducing an osmotic pressure necessary for permeation of water in seawater 20 into the desalting membrane 15. The functional groups introduced from the silane coupling agent swell with water which has permeated the desalting membrane 15, but are not dissolved in the water. The functional groups, introduced from the silane coupling agent, are bonded to the modified base material 16, and thus are not separated from the modified base material 16, and remain stably on the surface of the modified base material 16. As a result, the water, which has permeated the desalting membrane 15, moves stably to the fresh water side through the modified base material 16, and then is recovered. When using the apparatus, accordingly, an operation which is required in conventional methods, i.e., an operation in which using an ammonium chloride solution having a high salt concentration, water in seawater is forced to permeate the osmosis membrane and to move into the ammonium chloride solution, then the solution is heated to 60° C. or higher, and ammonia and carbon dioxide are released as gases, particularly a heating treatment, is not required. In addition, the functional groups, which are introduced from a specific concentration of the silane coupling agent, exist always in the state in which they are closely brought into contact with the fresh water side of the desalting membrane, whereby water moves from the salt water side to the fresh water side. Consequently, it is not required to always apply a high pressure toward the desalting membrane 15 from the salt water side, as in the reverse osmosis membrane method. According to the embodiment, therefore, the desalination of salt water can be performed at low energy.

### Third Embodiment

A desalination treatment membrane according to a third embodiment is explained in detailed below.

The desalination treatment membrane according to the embodiment comprises a desalting membrane, and a base material disposed in close contact with the desalting membrane. Functional groups are bonded on one surface the base material, and represented by the formula (II) or (III) as a structural unit.

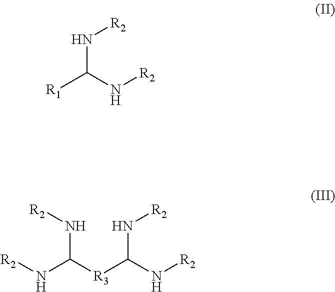

wherein R1 is H or an alkyl group having 5 or less carbon atoms; R2 is a polyamine or a polyethylene imine; and R3 is an alkyl group having 5 or less carbon atoms.

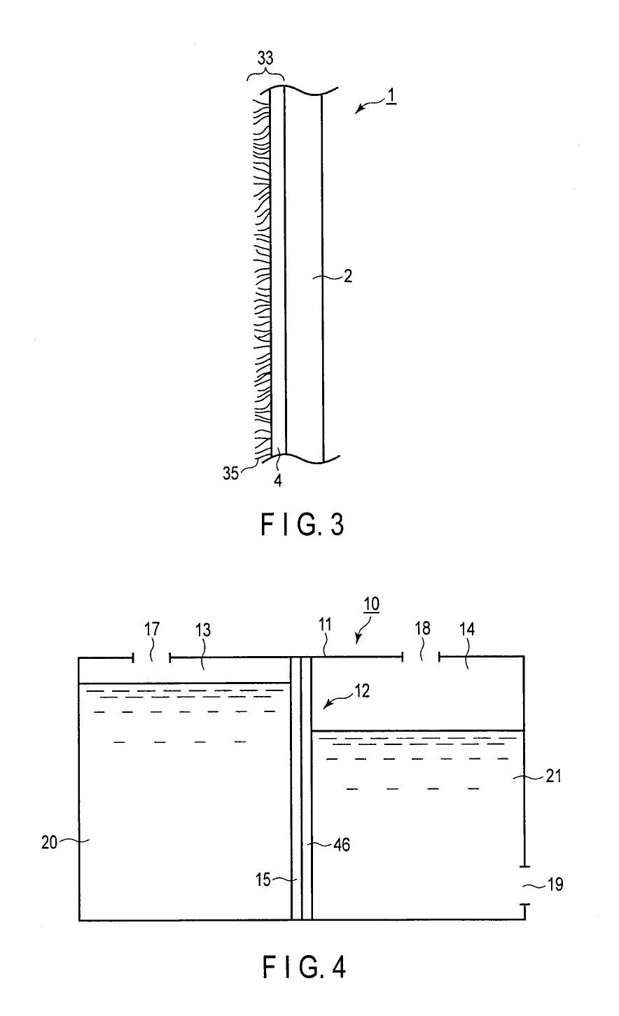

Using FIG. 3, the desalination treatment membrane is explained. A desalination treatment membrane 1 comprises a desalting membrane 2, and a modified base material 33 disposed in close contact with the desalting membrane 2, and the modified base material 33 carrying the functional groups including groups of the formula (II) or (III) as the structure unit on a surface of the base material 4 opposite to the desalting membrane 2.

As the desalting membrane 2, a membrane which is utilized as an osmosis membrane, such as a cellulose acetate membrane or a polyamide membrane, may be used. The desalting membrane has preferably a thickness of 45 μm to 250 μm.

As the base material 4, for example, a paper, cotton, a cellulose membrane such as cupra, rayon or copper ammonium rayon, a fabric, or a resin membrane may be used. Of these, a soft paper such as a filter paper and a non-woven fabric, which are capable of preventing damage to the desalting membrane under pressure, are preferable. In order to reduce a pressure loss as much as possible, it is preferable to use a base material having a higher water-permeability. The base material has preferably a thickness of, for example, 1 μm to 100 μm.

The base material 4 may be in the state of single fibers or multiple fibers, or beads. When it is in the state of single fibers or multiple fibers, the fiber may be pieces of the cellulose membrane, fabric or resin membrane, or fibers obtained by disentangling them.

Resin beads may also be used as the base material 4. In this case, the resin used may be, for example, resins capable of introducing the silane coupling agent such as polyvinyl alcohol, cellulose, processed cellulose and polyacrylic acid. The base material 4 which is subjected to the silane coupling treatment is also referred to as the “silane coupling base material”. The resin beads may have a size of 0.01 mm to 2 mm, and may have a size of 1 mm to 5 mm, in terms of the passage of water.

The base material 4 formed of the resin beads or fiber disposed may have a size of 0.01 mm to 5 mm, preferably 1 mm to 5 mm.

In such a case, the fiber base material 4 disposed may have a thickness of 10 μm to 100 μm.

The functional group 35 is a polymer including the structural units of the formula (II) or (III), and its molecular weight may be from 100 to 100000, for example, from 1000 to 50000, from 1000 to 10000, or from 1000 to 5000. The effects of the desalination treatment membrane according to the embodiment do not depend on the molecular weight of the functional group.

Such a functional group 35 may be formed by the reaction of an aldehyde with an amine, i.e., an aldol reaction. The aldol reaction used may be performed in reaction conditions already known. A reaction of the aldehyde compound with a compound having 2 or more amino groups may be performed, for example, through a reaction route I or II described below:

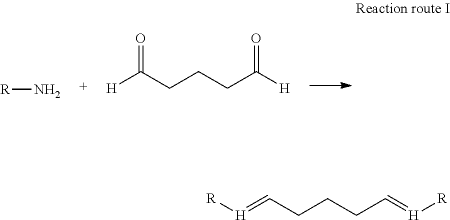

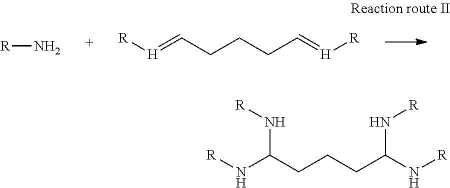

wherein R is H or an alkyl group having 5 or less carbon atoms. Examples of the alkyl group include Me, Et, Pr, Bu, Pentyl, isoPr, isoBu, isoPentyl.

For example, a compound obtained by a reaction of a dialdehyde compound with the compound having 2 or more amino groups, i.e., the polyamine, or a compound obtained by a reaction of formaldehyde with the compound having 2 or more amino groups, i.e., the polyamine, may be bonded to the base material 4 as the functional group 35.

Examples of the polyamine may include, but are not limited to, polyethylene imine, pentaethylene hexamine, tris(2-aminoethyl)amine, ethylene diamine, diethylene triamine, triethylene tetramine, tetraethylene tetramine, tetraethylene pentamine, dipropylene triamine, dimethyl aminopropyl amine, diethyl aminopropyl amine, hexamethylene diamine, dipropylene triamine, pentaethylene hexamine, menthene diamine, diaminodiphenyl sulfone, and the like.

Examples of the aldehyde may include, but are not limited to, glyoxal, butane dialdehyde, butene dialdehyde, glutardialdehyde, adipaldehyde, octane dialdehyde, 2,6-dialdehyde pyridine, 2,4-dialdehyde pyridine, 2,4,6-trialdehyde pyridine, ethylenediamine tetracetaldehyde, porphyrine tetraldehyde, and the like.

The functional group 35 may be, for example, polyethylene imine (PEI), pentaethylene hexamine (PEH) and/or tris(2-aminoethyl)amine (TAEA).

The polyethylene imine (PEI) is represented by, for example, the formula (IV):

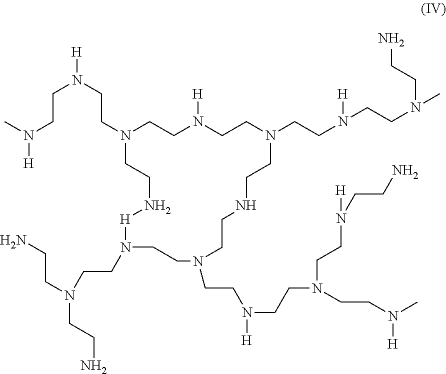

A polymer having the structural units of the formula (IV) is formed by the reaction described above as the functional group 35, which is bonded to the base material 4 and is used.

Pentaethylene hexamine (PEH) is represented by the formula (V). A polymer having structural units of the formula (V), for example, a polymer represented by the formula (VI):

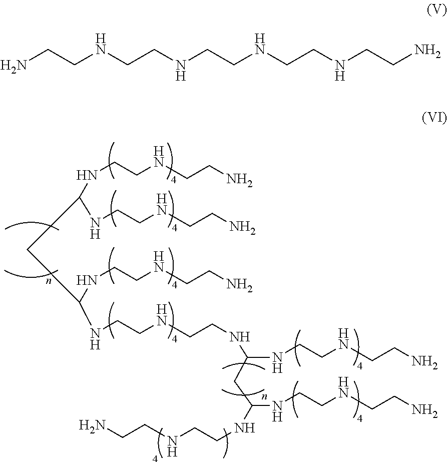

wherein n is an integer of 1 or more, preferably an integer of 10 to 100 is formed by the reaction described above as the functional group 35, which is bonded to the base material 4 and is used.

Tris(2-aminoethyl)amine (TAEA) is represented by the formula (VII). A polymer having structural unit of the formula (VII), for example a polymer of the formula (VIII):

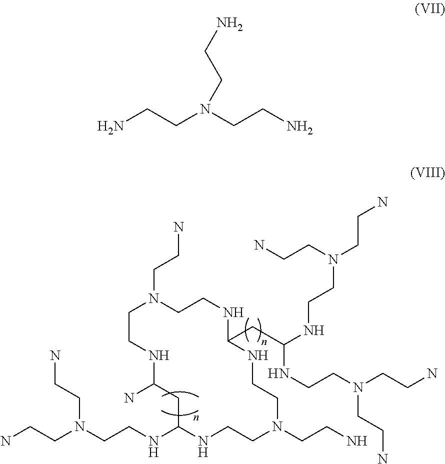

wherein n is an integer of 1 or more, preferably an integer of 10 to 100 is formed by the reaction described above as the functional group 35, which is bonded to the base material 4 and is used.

The functional groups 35 are bonded to the base material 4 so as to obtain a compound of the formula (IX) in a case of a monofunctional aldehyde, or a compound of the formula (X) in a case of a difunctional aldehyde.

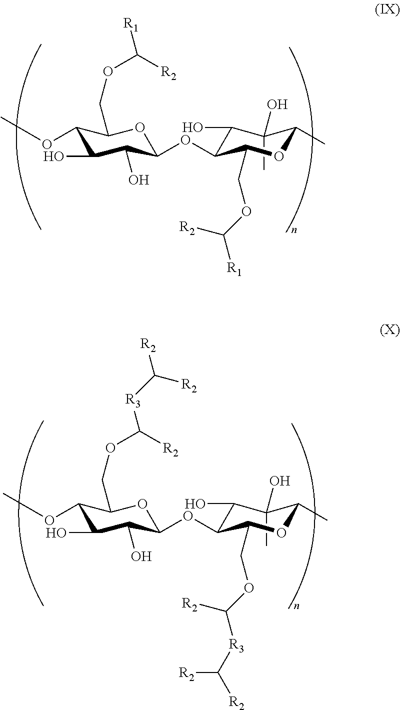

wherein R1 is H or an alkyl group having 5 or less carbon atoms; R2 is a polyamine or a polyethylene imine; R3 is an alkyl group having 5 or less carbon atoms; and n is an integer of 1 or more, preferably from an integer of 10 to 100. The formyl group included in the functional group 35 is bonded to a reactive group in the base material 4, for example, an OH group in a case of cellulose to form an acetal-like bond, whereby the functional group 35 is bonded to the base material 4.

The functional groups 35 may be bonded to one surface of the base material 4, and they are bonded to a surface thereof different from a surface brought into contact with the desalting membrane 2. It is preferable that the base material 4 to which the functional groups 35 are bonded is closely brought into contact with the active layer side of the desalting membrane 2.

Using such a desalination treatment membrane 1, water (fresh water) can be taken out from salt water. In such a case, the surface of the desalination treatment membrane 1 to which the functional groups 35 are not bonded is disposed on the salt water side, and the surface to which functional groups 35 are bonded is disposed on the fresh water side.

According to the conventional forward osmotic pressure seawater desalination method, basically, fresh water is absorbed from seawater and recovered. For that reason, a solution having a higher salt concentration than that of seawater is located at an opposite side to the seawater across the osmosis membrane 2, thereby inducing an osmotic pressure necessary for permeation of water in the seawater through the osmosis membrane 2 to force the water into the solution having a higher salt concentration. Ammonium chloride has been conventionally used as the salt. Ammonium chloride has a high solubility in water, and is decomposed at 60° C. to release ammonia and carbon dioxide as gases. Thus, the remaining water is fresh water. The water permeating through the desalting membrane 1 stably moves to the fresh water side through the modified base material 33, and is recovered. According to the conventional method using the ammonium chloride solution having a high salt concentration, therefore, operations are required in which water in the seawater is forced to permeate the osmosis membrane and to move into an ammonium chloride solution, and then the solution is heated to 60° C. or higher to release ammonia and carbon dioxide as gases. On the contrary, according to the embodiment, the heating treatment is not required. In addition, when the same pressure as that used in the RO method which has been conventionally performed is applied, it is possible to more quickly obtain fresh water from salt water at a higher flow rate compared to the conventional RO method. Furthermore, even if a lower pressure is applied, fresh water can be obtained from salt water. It is possible, therefore, to perform the desalination of salt water at lower energy than that expended in the conventional method.

### Fourth Embodiment

A desalination treatment apparatus 10 according to a fourth embodiment is explained referring to FIG. 4 below. In FIG. 4, the same symbols are assigned the members same as those in FIG. 2 and their explanation is omitted.

In the fourth embodiment, a desalination treatment membrane 12 disposed in a hollow rectangular sealing treatment vessel 11 of the desalination treatment apparatus 10 is formed of a desalting membrane 15, and a modified base material 16, which is disposed in close contact with this desalting membrane 15, and carries functional groups on the one surface thereof. The desalting membrane 15 in the desalination treatment membrane 12 is disposed on the side of a first chamber 13 in which salt water 20 is housed, and the modified base material 46 is disposed on the side of a second chamber 14 in which fresh water 21 is housed.

In the desalination treatment apparatus 10 according to such an embodiment, the desalting membrane 15 is disposed on the seawater 20 side, and the modified base material 46 is disposed on the fresh water 21 side. At this time, the functional groups, which are bonded to the base material in the modified base material 46, have an action of inducing an osmotic pressure necessary for permeation of water in seawater 20 into the desalting membrane 15. Such functional groups, therefore, can cause an osmotic pressure, which is directed toward the fresh water side of the desalting membrane from the seawater side thereof. The functional groups swell with water which has permeated the desalting membrane 15, but are not dissolved in the water within a given temperature range. The functional groups are bonded to the modified base material 46, and thus are not separated from the modified base material 46, and remain stably on the surface of the modified base material 46. As a result, the water, which has permeated the desalting membrane 15, moves stably to the fresh water side through the modified base material 46, and then is recovered. According to the embodiment, the heating treatment is not required, as in the second embodiment described above. In addition, the functional groups exist always on the fresh water side of the desalting membrane, whereby water moves from the salt water side to the fresh water side, and thus it is not required to always apply a high pressure toward the desalting membrane 15 from the salt water side, as in the reverse osmosis membrane method. According to the embodiment, therefore, the desalination of salt water can be performed at low energy.

### Fifth Embodiment

A desalination treatment membrane according to a fifth embodiment is explained in detailed below.

The fifth embodiment is an embodiment obtained based on findings described the following. That is, when polyethylene imine is disposed in the vicinity of a side which is not brought into contact with the seawater side, i.e., fresh water side, of the desalination treatment membrane, an osmotic pressure directed to the fresh water side of the desalting membrane from the seawater side thereof can be caused.

The desalination treatment membrane according to the embodiment comprises a desalting membrane, and functional groups which are carried on one surface of this desalting membrane and comprising polyethylene imine.

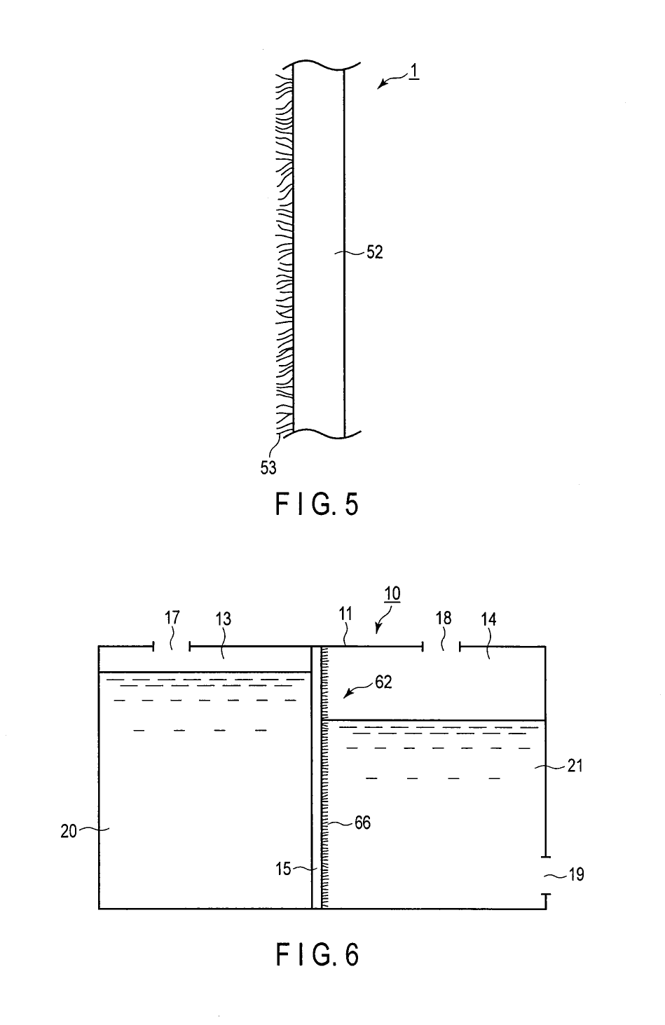

A desalination treatment membrane 1 comprises specifically a desalting membrane 52, and functional groups 53 which are carried on one surface of the desalting membrane 52, as shown in FIG. 5.

As the desalting membrane 52, a membrane which is utilized as an osmosis membrane, such as a cellulose acetate membrane or a polyamide membrane, may be used. The desalting membrane has preferably a thickness of 45 μm to 250 μm.

The functional group 53 may be polyethylene imine, and the molecular weight thereof may be from 600 to 70000, for example, 25000. The effects of the desalination treatment membrane according to the embodiment do not depend on the molecular weight of the functional group. A structure of the polyethylene imine may be represented, for example, by the formula (IV):

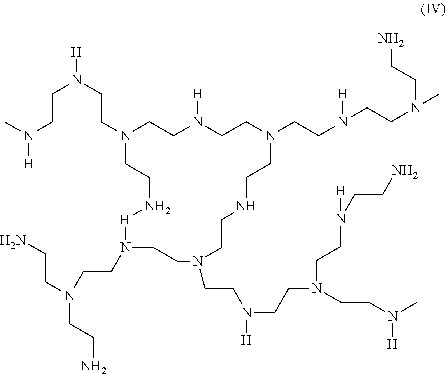

The polyethylene imine functions as a cation in the functional group 53. An anion, which is a counter ion thereof, may be a chlorine ion, sulfate ion, phosphate ion, or trifluoroacetate ion, and chlorine ion is preferable.

Such functional groups 53 are formed by bonding polyethylene imine to the desalting membrane 52 in any known method. For example, they may be bonded utilizing the aldehyde described above.

It is enough that the functional groups 53 are bonded to one surface of the desalting membrane 52, and they are preferably bonded to an active layer side of the desalting membrane 52.

In a desalination treatment method in which water (fresh water) is taken out from salt water using such a desalination treatment membrane, a surface to which the functional groups are not bonded of the desalination treatment membrane is disposed on salt water side, and a surface to which the functional groups are bonded is disposed on fresh water side.

According to the forward osmotic pressure seawater desalination method, basically, fresh water is absorbed from seawater and recovered. For that reason, a solution having a higher salt concentration than that of seawater is located at an opposite side to the seawater across the osmosis membrane, thereby inducing an osmotic pressure necessary for permeation of water in the seawater through the osmosis membrane to force the water into the solution having a higher salt concentration. Ammonium chloride has been conventionally used as the salt. Ammonium chloride has a high solubility in water, and is decomposed at 60° C. to release ammonia and carbon dioxide as gases. Thus, the remaining water is fresh water. The water permeating through the desalting membrane stably moves to the fresh water side through the desalting membrane, and is recovered. According to the conventional method using the ammonium chloride solution having a high salt concentration, therefore, operations are required in which water in the seawater is forced to permeate the osmosis membrane and to move into an ammonium chloride solution, and then the solution is heated to 60° C. or higher to release ammonia and carbon dioxide therefrom as gases. According to the embodiment, however, the heating treatment is not required. In addition, when the same pressure as that used in the RO method which has been conventionally performed is applied, it is possible to more quickly obtain fresh water from salt water at a higher flow rate compared to the conventional RO method. Furthermore, even if a lower pressure is applied, fresh water can be obtained from salt water. It is possible, therefore, to perform the desalination of salt water at lower energy than that expended in the conventional method.

In addition, as described above, the polyethylene imine may be bonded to the base material instead of the desalting membrane. In such a case, the base material modified with the polyethylene imine may be disposed in close contact with the desalting membrane.

Such a desalination treatment membrane comprises a desalting membrane, and a base material which is disposed in close contact with this desalting membrane, and carries the functional groups including the polyethylene imine on at least a part of the surface thereof.

As the base material, for example, a paper, cotton, a cellulose membrane such as cupra, rayon or copper ammonium rayon, a fabric, or a resin membrane may be used. Of these, a soft paper such as a filter paper and a non-woven fabric, which are capable of preventing damage to the desalting membrane under pressure, are preferable. In order to reduce a pressure loss as much as possible, it is preferable to use a base material having a higher water-permeability. The base material has preferably a thickness of, for example, 1 μm to 100 μm.

The base material 4 may be in the state of single fibers or multiple fibers, or beads. When it is in the state of single fibers or multiple fibers, the fiber may be pieces of the cellulose membrane, fabric or resin membrane, or fibers obtained by disentangling them.

A base material in the state of beads may be used. In this case, the resin used may be, for example, resins capable of bonding the functional groups 35 including the polyethylene imine, such as polyvinyl alcohol, cellulose, processed cellulose and polyacrylic acid. The resin beads may have a size of 0.01 mm to 2 mm, and may have a size of 1 mm to 5 mm, in terms of the passage of water.

The polyethylene imine may be bonded to the base material in the same manner as in the bonding of the polyethylene imine to the desalting membrane.

The same effects as those obtained in the case where the polyethylene imine is bonded to the desalting membrane can also be obtained in this case. As a result, the desalination of salt water can be performed at lower energy than that expended in the conventional methods.

### Sixth Embodiment

A desalination treatment apparatus 10 according to a sixth embodiment is explained referring to FIG. 6 below. In FIG. 6, the same symbols are assigned the members same as those in FIG. 2 and their explanation is omitted.

In the sixth embodiment, a desalination treatment membrane 62 disposed in a hollow rectangular sealing treatment vessel 11 of the desalination treatment apparatus 10 is formed of a desalting membrane 15, and functional groups 66 including polyethylene imine, which are carried on one surface of this desalting membrane 15. A surface of the desalination treatment membrane 62 on which the functional groups 66 do not exist is disposed on the side of a first chamber 13 in which salt water 20 is housed, and the functional groups 66 are disposed on a side of a second chamber 14 in which fresh water 21 is housed.

In the desalination treatment apparatus 10 according to such an embodiment, the surface of the desalting membrane 15 on which the functional groups 66 are not carried is disposed on the seawater 20 side, and the surface on which the functional groups 66 are carried is disposed on the fresh water 21 side. At this time, the functional groups 66, which are bonded to the desalting membrane 15, have an action of inducing an osmotic pressure necessary for permeation of water in seawater 20 into the desalting membrane 15. Such functional groups, therefore, can cause an osmotic pressure directed toward the fresh water side of the desalting membrane from the seawater side thereof. The functional groups 66 swell with water which has permeated the desalting membrane 15, but are not dissolved in the water within a given temperature range. The functional groups 66 are bonded to the desalting membrane 15, and thus are not separated from the desalting membrane 15, and remain stably on the surface of the desalting membrane 15. As a result, the water, which has permeated the desalting membrane 15, moves stably to the fresh water side through the desalting membrane 15, and then is recovered. According to the conventional method using the ammonium chloride solution having a high salt concentration, therefore, operations are required in which water in the seawater is forced to permeate the osmosis membrane and to move into an ammonium chloride solution, and then the solution is heated to 60° C. or higher to release ammonia and carbon dioxide as gases. According to the embodiment, however, the heating treatment is not required. In addition, the functional groups 66 exist always on the fresh water side of the desalting membrane 62, whereby water moves from the salt water side to the fresh water side, and thus it is not required to always apply a high pressure toward the desalting membrane 15 from the salt water side, as in the reverse osmosis membrane method. According to the embodiment, therefore, the desalination of salt water can be performed at low energy.

In the sixth embodiment described above, a polyethylene imine modified base material formed from polyethylene imine which is bonded to the base material may be used. In such a case, the functional groups are not bonded to the desalting membrane 62, the desalting membrane 15 is disposed on the salt water side of the desalting membrane 62, and the polyethylene imine modified base material is disposed in close contact therewith. At this time, the polyethylene imine modified base material may be disposed on the fresh water side.

### Seventh Embodiment

A desalination treatment membrane, a desalination treatment method and a desalination treatment layer according to a seventh embodiment are explained in detailed below.

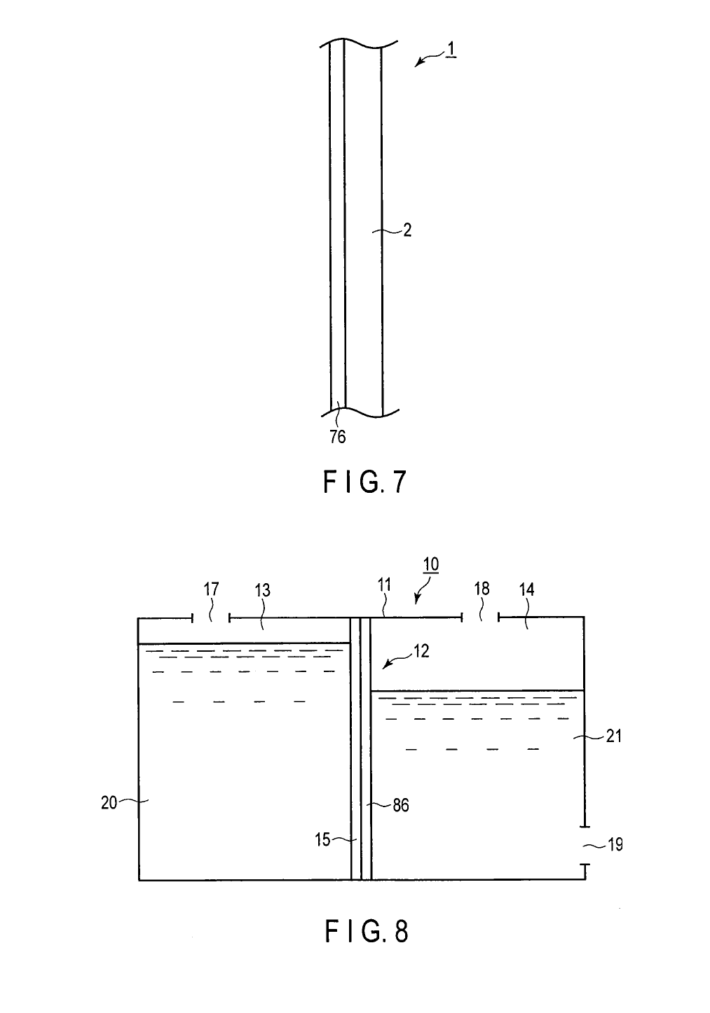

The desalination treatment membrane according to the embodiment comprises a desalting membrane, and an ion exchange resin or pulverized ion exchange resin, which is disposed in close contact with this desalting membrane. As shown in FIG. 7, a desalination treatment membrane 1 specifically comprises a desalting membrane 2, and an ion exchange resin or pulverized ion exchange resin 76, which is disposed in close contact with this desalting membrane 2.

In a desalination treatment method in which water (fresh water) is taken out from salt water using such a desalination treatment membrane 1, the desalting membrane 2 in the desalination treatment membrane 1 is disposed on the salt water side, and the ion exchange resin or pulverized ion exchange resin 76 is disposed on the fresh water side.

According to the forward osmotic pressure seawater desalination method, basically, fresh water is absorbed from seawater and recovered. For that reason, a solution having a higher salt concentration than that of seawater is located at an opposite side to the seawater across the osmosis membrane, thereby inducing an osmotic pressure necessary for permeation of water in the seawater through the osmosis membrane to force the water into the solution having a higher salt concentration. Ammonium chloride has been conventionally used as the salt. Ammonium chloride has a high solubility in water, and is decomposed at 60° C. to release ammonia and carbon dioxide as gases. Thus, the remaining water is fresh water.

In the embodiment, instead of the solution having a higher salt concentration described above, the ion exchange resin or pulverized ion exchange resin is disposed in close contact with the desalting membrane. In the desalination treatment method using the desalination treatment membrane in which the ion exchange resin or pulverized ion exchange resin is disposed in close contact with the desalting membrane, therefore, the desalting membrane is disposed on the seawater side, and the ion exchange resin or pulverized ion exchange resin is disposed on the fresh water side. At this time, functional groups included in the ion exchange resin or pulverized ion exchange resin have an action of inducing an osmotic pressure necessary for permeation of water in seawater into the desalting membrane. In addition, the functional groups included in the ion exchange resin or pulverized ion exchange resin swell with water which has permeated the desalting membrane, but are not dissolved in the water. The functional groups, included in the ion exchange resin or pulverized ion exchange resin, are bonded to the base material, and thus are not separated from the modified base material, and remain stably on the surface of the base material. As a result, the water, which has permeated the desalting membrane, moves stably to the fresh water side through the ion exchange resin or pulverized ion exchange resin, and then is recovered. According to the conventional method using the ammonium chloride solution having a high salt concentration, therefore, operations are required in which water in the seawater is forced to permeate the osmosis membrane and to move into an ammonium chloride solution, and then the solution is heated to 60° C. or higher to release ammonia and carbon dioxide as gases. According to the present embodiment, however, the heating treatment is not required. In addition, when the same pressure as that used in the RO method which has been conventionally performed is applied, it is possible to more quickly obtain fresh water from salt water at a higher flow rate compared to the conventional RO method. Furthermore, even if a lower pressure is applied, it is possible to obtain fresh water from salt water. It is possible, therefore, to perform the desalination of salt water at lower energy than that expended in the conventional method.

As the desalting membrane, a membrane which is utilized as an osmosis membrane, such as a cellulose acetate membrane or a polyamide membrane, may be used. The desalting membrane has preferably a thickness of 45 μm to 250 μm.

The ion exchange resin may be an already-known ion exchange resin, such as a cationic ion exchange resin or an anion exchange resin. The functional group included in the ion exchange resin may include a sulfonate group, a carboxylate group or a quarternary ammonium group.

The ion exchange resin may have a thickness of 10 μm to 100 μm, preferably 10 μm to 30 μm. The ion exchange resin may have a pore size of 1 μm to 10 μm, preferably 4 μm to 7 μm. It is preferable to dispose the ion exchange resin or pulverized ion exchange resin having a thickness of, for example, 0.1 μm to 100 μm.

The ion exchange resin may be pulverized, for example, using a mortar. The pulverized ion exchange resin may have a size of 0.01 μm to 10 μm.

In the embodiment described above, instead of the ion exchange resin or pulverized ion exchange resin, an ion exchange filter paper may be used. The kind of the ion exchange filter paper may be a cation exchange resin, an anion exchange resin, or the like. The fibrious ion exchange filter paper, obtained by disentanglement thereof, may also be used.

### Eighth Embodiment

Next, a desalination treatment apparatus 10 according to an eighth embodiment is explained, referring to FIG. 8. In FIG. 8, the same symbols are assigned the members same as those in FIG. 2 and their explanation is omitted.

In the eighth embodiment, a desalination treatment membrane 12 disposed in a hollow rectangular sealing treatment vessel 11 of the desalination treatment apparatus 10 is formed of a desalting membrane 15, and an ion exchange resin or pulverized ion exchange resin 86, which is disposed in close contact with this desalting membrane 15. The desalting membrane 15 in the desalination treatment membrane 12 is disposed on a side of a first chamber 13 in which salt water 20 is housed, and the ion exchange resin or pulverized ion exchange resin 86 is disposed on a side of a second chamber 14 in which fresh water 21 is housed.

In the desalination treatment apparatus 10 according to such an embodiment, the desalting membrane 15 is disposed on the seawater 20 side, and the ion exchange resin or pulverized ion exchange resin 86 is disposed on the fresh water 21 side. At this time, the functional groups, which are included in the ion exchange resin or pulverized ion exchange resin, have an action of inducing an osmotic pressure necessary for permeation of water in seawater 20 into the desalting membrane 15. The functional groups included in the ion exchange resin or pulverized ion exchange resin swell with water which has permeated the desalting membrane 15, but are not dissolved in the water within a given temperature range. The functional groups, included in the ion exchange resin or pulverized ion exchange resin, are bonded to the base material, and thus are not separated from the base material, and remain stably on the surface of the base material. As a result, the water, which has permeated the desalting membrane 15, moves stably to the fresh water side through the ion exchange resin or pulverized ion exchange resin, and then is recovered. According to the conventional method using the ammonium chloride solution having a high salt concentration, therefore, operations are required in which water in the seawater is forced to permeate the osmosis membrane and to move into an ammonium chloride solution, and then the solution is heated to 60° C. or higher to release ammonia and carbon dioxide as gases. According to the embodiment, however, the heating treatment is not required. In addition, the functional groups, included in a specific concentration of the ion exchange resin or pulverized ion exchange resin disposed in close contact with the desalting membrane, exist always on the fresh water side of the desalting membrane, whereby water moves from the salt water side to the fresh water side, and thus it is not required to always apply a high pressure toward the desalting membrane 15 from the salt water side, as in the reverse osmosis membrane method. According to the embodiment, therefore, the desalination of salt water can be performed at low energy.

In the eighth embodiment described above, instead of the ion exchange resin or pulverized ion exchange resin, an ion exchange filter paper may be used. The kind of the ion exchange filter paper may be a cation exchange resin, an anion exchange resin, or the like. The fibrious ion exchange filter paper, obtained by disentanglement thereof, may also be used.

### Ninth Embodiment

A desalination treatment membrane according to a ninth embodiment is explained in detailed below.

The desalination treatment membrane according to the embodiment comprises a desalting membrane, and a base material, which is disposed in close contact with this desalting membrane, and carries functional groups having structure units represented by the formula (XI) on its one surface.

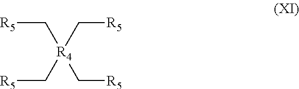

wherein R4 is an alkylene group or an aromatic group; and R5 is a polyamine, a halogen or a polymer forming a carrier.

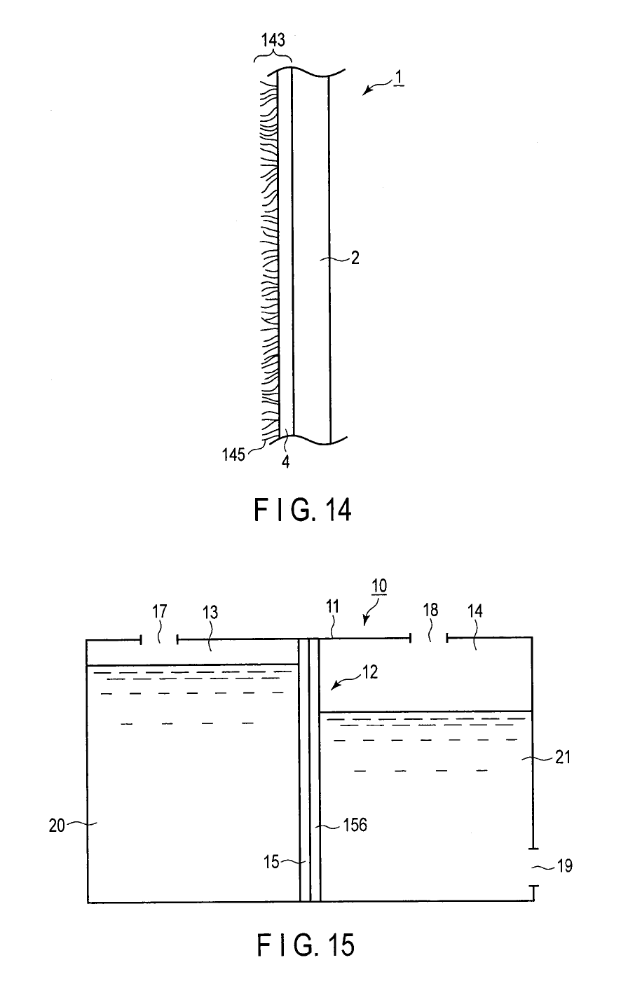

The desalination treatment membrane 1 specifically comprises a desalting membrane 2, and a modified base material 143, which is disposed in close contact with the desalting membrane 2, and functional groups having structural units represented by the formula (XI), as shown in FIG. 14. The modified base material 143 carries a base material 4, and functional groups 145 including groups of the formula (XI) or (III) as a structural unit on a surface of the base material 4 opposite to the desalting membrane 2.

As the desalting membrane 2, a membrane which is utilized as an osmosis membrane, such as a cellulose acetate membrane or a polyamide membrane, may be used. The desalting membrane has preferably a thickness of 45 μm to 250 μm.

As the base material 4, for example, a paper, cotton, a cellulose membrane such as cupra, rayon or copper ammonium rayon, a fabric, or a resin membrane may be used. Of these, a soft paper such as a filter paper and a non-woven fabric, which are capable of preventing damage to the desalting membrane under pressure, are preferable. In order to reduce a pressure loss as much as possible, it is preferable to use a base material having a higher water-permeability. The base material 4 has preferably a thickness of, for example, 1 μm to 100 μm.

In addition, as the base material 4, for example, natural polymers (biopolymer) shown below may be used. Specifically, it is exemplified by proteins, nucleic acid, lipid, polysaccharides (cellulose, starch), natural rubbers, and the like. Synthetic polymers may include polyvinyl chloride, polyethylene, epoxy resins, polystyrene, phenol resins, nylon, vinylon, polyester, polyethylene terephthalate, silicon resins, and the like. The functional groups 145 are bonded to the base material 4. Specifically, a cationic resin is bonded to the backbone of the base material 4 through a halogenated compound which serves as a cross-linking agent, and in this case, an organic halogenated compound having two or more halogen atoms per molecule is appropriate. At this time, it is preferable that all of the halogenated alkyl groups are not reacted, unreacted parts remains in a certain percentage, because an amount of the polyamine introduced becomes small if there are a few unreacted parts.

The base material may be in the state of single fibers or multiple fibers, or beads. When it is in the state of single fibers or multiple fibers, the fiber may be pieces of the cellulose membrane, fabric or resin membrane, or fibers obtained by disentanglement thereof.

Resin beads may also be used as the base material. In this case, the resin used may be, for example, resins capable of bonding of the functional groups 145 having the structural units represented by the formula (XI), such as polyvinyl alcohol, cellulose, processed cellulose and polyacrylic acid, and further silica particles which are not a resin though. The beads may have a size of 0.01 mm to 5 mm, preferably 2 mm to 5 mm.

The functional group 145 is a cationic polymer having the structural units represented by the formula (XI), and its molecular weight may be from 100 to 100000, for example, from 1000 to 50000, from 1000 to 10000, or from 1000 to 5000. The effects of the desalination treatment membrane according to the embodiment, however, do not depend on the molecular weight of the functional group.

Chlorine ion is preferable as a counter anion of the cationic polymer in the functional group 145, because it is safe.

Such a functional group may be formed by reaction of polyamine with a halogenated alkyl group-containing crosslinking agent by heating them.

Examples of the polyamine may include, but are not limited to, polyethylene imine, pentaethylene hexamine, tris(2-aminoethyl)amine, ethylene diamine, diethylene triamine, triethylene tetramine, tetraethylene tetramine, tetraethylene pentamine, dipropylene triamine, dimethylaminopropyl amine, diethylaminopropyl amine, hexamethylene diamine, dipropylene triamine, pentaethylene hexamine, menthene diamine, diaminodiphenyl sulfone, and the like.

Examples of the halogenated alkyl group-containing crosslinking agent may include, but are not limited to, polufunctional halogenated compounds such as dibromomethane, dibromoethane, dibromopropane, dibromobutane, dibromopentane, dibromohexane, dibromoheptane, dibromoctane, dibromononane, dibromodecane, dibromoundecane, dibromododecane, dibromotridecane, dichloromethane, dichloroethane, dichloropropane, dichlorobutane, dichloropentane, dichlorohexane, dichloroheptane, dichloroctane, dichlorononane, dichlorodecane, dichloroundecane, dichlorododecane, dichlorotridecane, diiodomethane, diiodoethane, diiodopropane, diiodobutane, diiodopentane, diiodohexane, diiodoheptane, diiodoctane, diiodononane, diiododecane, diiodoundecane, diiodododecane, diiodotridecane, 1,2,4,5-tetrakisbromomethyl benzene, 1,4-bisbromomethyl benzene, 1,4-bisiodomethyl benzene, 10,10-bisbromomethyl nonadecane, epichlorohydrion oligomers, epibromohydrin oligomers, hexabromocyclododecane, tris(3,3-dibromo-2-bromopropyl)isocyanuric acid, 1,2,3-tribromopropane, diiodoperfluoroethane, diiodoperfluoropropane, diiodoperfluorohexane, polyepichlorohydrine, copolymers of polyepichlorohydrin and polyethylene ether, polyepibromohydrin, and polyvinyl chloride. The kind of the organic halogenated compound used may be one or two or more. Of these, 1,2,4,5-tetrakis(bromomethyl)benzene and tetrakis(bromomethyl)methane are preferable, because there is no side reaction.

In a desalination treatment method in which water (fresh water) is taken out from salt water using such a desalination treatment membrane, the surface of the desalination treatment membrane to which the functional groups are not bonded is disposed on the salt water side, and the surface to which the functional groups are bonded is disposed on the fresh water side.

According to the forward osmotic pressure seawater desalination method, basically, fresh water is absorbed from seawater and recovered. For that reason, a solution having a higher salt concentration than that of seawater is located at an opposite side to the seawater across the osmosis membrane, thereby inducing an osmotic pressure necessary for permeation of water in the seawater through the osmosis membrane to force the water into the solution having a higher salt concentration. Ammonium chloride has been conventionally used as the salt. Ammonium chloride has a high solubility in water, and is decomposed at 60° C. to release ammonia and carbon dioxide as gases. Thus, the remaining water is fresh water. The water permeating through the desalting membrane stably moves to the fresh water side through the desalting membrane, and is recovered. According to the conventional method using the ammonium chloride solution having a high salt concentration, therefore, operations are required in which water in the seawater is forced to permeate the osmosis membrane and to move into an ammonium chloride solution, and then the solution is heated to 60° C. or higher to release ammonia and carbon dioxide there from as gases. According to the embodiment, however, the heating treatment is not required. In addition, when the same pressure as that used in the RO method which has been conventionally performed is applied, it is possible to more quickly obtain fresh water from salt water at a higher flow rate compared to the conventional RO method. Furthermore, even if a lower pressure is applied, fresh water can be obtained from salt water. It is possible, therefore, to perform the desalination of salt water at lower energy than that expended in the conventional method.

### Tenth Embodiment

Next a desalination treatment apparatus 10 according to a tenth embodiment is explained referring to FIG. 15. In FIG. 15, the same symbols are assigned the members same as those in FIG. 2 and their explanation is omitted.

In the eighth embodiment, a desalination treatment membrane 12 disposed in a hollow rectangular sealing treatment vessel 11 of the desalination treatment apparatus 10 is formed of a desalting membrane 15, and a modified base material 156, which is disposed in close contact with this desalting membrane 15, and carries functional groups on its one surface. The desalting membrane 15 in the desalination treatment membrane 12 is disposed on a side of a first chamber 13 in which salt water 20 is housed. The modified base material 156 is disposed on a side of a second chamber 14 in which fresh water 21 is housed.

In the desalination treatment apparatus 10 according to such an embodiment, the desalting membrane 15 is disposed on the seawater 20 side, and the modified base material 156 is disposed on the fresh water 21 side. At this time, the functional groups, which are bonded to the modified base material 156, have an action of inducing an osmotic pressure necessary for permeation of water in seawater 20 into the desalting membrane 15. Such functional groups, therefore, can cause an osmotic pressure, which is directed toward the fresh water side of the desalting membrane from the seawater side thereof. The functional groups swell with water which has permeated the desalting membrane 15, but are not dissolved in the water within a given temperature range. The functional groups are bonded to the desalting membrane 15, and thus are not separated from the desalting membrane 15, and remain stably on the surface of the desalting membrane 15. As a result, the water, which has permeated the desalting membrane 15, moves stably to the fresh water side through the desalting membrane 15, and then is recovered. According to the conventional method using the ammonium chloride solution having a high salt concentration, therefore, operations are required in which water in the seawater is forced to permeate the osmosis membrane and to move into an ammonium chloride solution, and then the solution is heated to 60° C. or higher to release ammonia and carbon dioxide as gases. According to the embodiment, however, the heating treatment is not required. In addition, the functional groups exist always on the fresh water side of the desalting membrane, whereby water moves from the salt water side to the fresh water side, and thus it is not required to always apply a high pressure toward the desalting membrane 15 from the salt water side, as in the reverse osmosis membrane method. According to the embodiment, therefore, the desalination of salt water can be performed at low energy.

In the second, the fourth, the sixth, the eighth, and the tenth embodiments described above, the example using the hollow rectangular sealing treatment vessel 11 has been shown, but the shape of the sealing treatment vessel 11 is not limited to being rectangular. The sealing treatment vessel 11 may have any shape, which is hollow, such as a circular, conical, rectangular column, or pyramid shape.

In the second, the fourth, the sixth, the eighth, and the tenth embodiments described above, the example of the horizontal type sealing treatment vessel 11 has been shown in which the first chamber 13 and the second chamber 14 are disposed in a row at the same height from an installation surface. The sealing treatment vessel 11, however, may be a vertical type. In the vertical type sealing treatment vessel 11, the first chamber 13 and the second chamber 14 are disposed, for example, above and below the installation surface. The first chamber 13 and the second chamber 14 may also be differently disposed. The first chamber 13 and the second chamber 14 may be disposed, for example, side by side through the desalination treatment membrane 22, at different heights from the installation surface.

In the second, the fourth, the sixth, the eighth, and the tenth embodiments described above, the desalination treatment apparatus may also have a structure wherein the desalination treatment membrane is housed in the sealing treatment vessel in the state in which at least one side of the membrane is rolled up in the center, and a desalination treatment membrane element is provided which can separate salt water from fresh water through the desalination treatment membrane.

In the second, the fourth, the sixth, the eighth, and the tenth embodiments described above, the example having the inlet 18 at the second chamber 14 has been shown, but the outlet 19 may be utilized as an inlet. In such a case, the inlet 18 may not be provided. The positions at which the inlets 17 and 18 and the outlet 19 are disposed are not limited to those in the embodiment described above.

### Example

### Case 1

<Introduction of Silane Coupling Agent into Filter Paper>

A silane coupling agent was introduced into a filter paper as shown below, thereby producing Examples 1 to 5.

### Production Method of Filter Paper (1)

To 10 mL of toluene was added 100 μL of N-2-(aminoethyl)-3-aminopropylmethyldimethoxysilane, and the mixture was thoroughly stirred. To this mixed liquid was added a filter paper (No 5B) for Kiriyama-rohto, and the reaction was performed at room temperature for one hour. After the reaction was completed, the filter paper was thoroughly washed with toluene, acetone, and H₂O. After that, amino groups were converted into hydrochloride with 1M of HCl aq., and then the excess HCl was thoroughly washed away with H₂O. The resulting filter paper was dried in an oven at 100° C. for 2 hours to obtain a desired filter paper (1), which was used as Example 1.

### Preparation Method of Filter Paper (2)

To 10 mL of toluene was added 300 μL of N-2-(aminoethyl)-3-aminopropylmethyldimethoxysilane, and the mixture was thoroughly stirred. To this mixed liquid was added a filter paper (No 5B) for Kiriyama-rohto, and the reaction was performed at room temperature for one hour. After the reaction was completed, the filter paper was thoroughly washed with toluene, acetone, and H₂O. After that, amino groups were converted into hydrochloride with 1M of HCl aq. The excess HCl was thoroughly washed away with H₂O. The resulting filter paper was dried in an oven at 100° C. for 2 hours to obtain a desired filter paper (2), which was used as Example 2.

### Production Method of Filter Paper (3)

With 10 mL of isopropyl alcohol was mixed 500 μL of N-2-(aminoethyl)-3-aminopropyltrimethoxysilane, and the mixture was thoroughly stirred. A filter paper (No 5B) for Kiriyama-rohto was immersed in the mixed liquid, and it was taken out therefrom, which was air-dried for 3 hours as it was. The reaction was performed by putting it in an oven at 70° C. for 3 hours, and it was washed thoroughly washed with H₂O. After that, amino groups were converted into hydrochloride with 1M of HCl aq. The excess HCl was thoroughly washed away with H₂O. The resulting filter paper was dried in an oven at 100° C. for 2 hours to obtain a desired filter paper (3), which was used as Example 3.

### Production Method of Filter Paper (4)

With 10 mL of isopropyl alcohol was mixed 500 μL of N-2-(aminoethyl)-3-aminopropyltrimethoxysilane, and the mixture was thoroughly stirred. A filter paper (No 5B) for Kiriyama-rohto was immersed in the mixed liquid, and it was taken out therefrom. After that, it was air-dried for 3 hours as it was. The resulting filter paper was immersed again in the mixed liquid above, which had been produced anew, and was taken out therefrom. After that, it was air-dried for 3 hours as it was. The reaction was performed by putting it in an oven at 70° C. for 3 hours, and it was washed thoroughly washed with H₂O. After that, amino groups were converted into hydrochloride with 1M of HCl aq. The excess HCl was thoroughly washed away with H₂O. The resulting filter paper was dried in an oven at 100° C. for 2 hours to obtain a desired filter paper (4), which was used as Example 4.

### Production Method of Filter Paper (5)

To 10 mL of isopropyl alcohol was added 500 μL of N-2-(aminoethyl)-3-aminopropyltrimethoxysilane, and the mixture was thoroughly stirred. A filter paper (No 5B) for Kiriyama-rohto was immersed in the mixed liquid, and it was taken out therefrom. After that, it was air-dried for 3 hours as it was. The resulting filter paper was immersed again in the mixed liquid above, which had been produced anew, and was taken out therefrom. After that, it was air-dried for 3 hours as it was. The resulting filter paper was immersed once again in the mixed liquid above, which had been produced anew, and was taken out there from. After that, it was air-dried for 3 hours as it was. The reaction was performed by putting it in an oven at 70° C. for 3 hours, and it was washed thoroughly washed with H₂O. After that, amino groups were converted into hydrochloride with 1M of HCl aq. The excess HCl was thoroughly washed away with H₂O. The resulting filter paper was dried in an oven at 100° C. for 2 hours to obtain a desired filter paper (5), which was used as Example 5.

### <Filter Paper Syringe Test>

### (1) Apparatus for Syringe Test

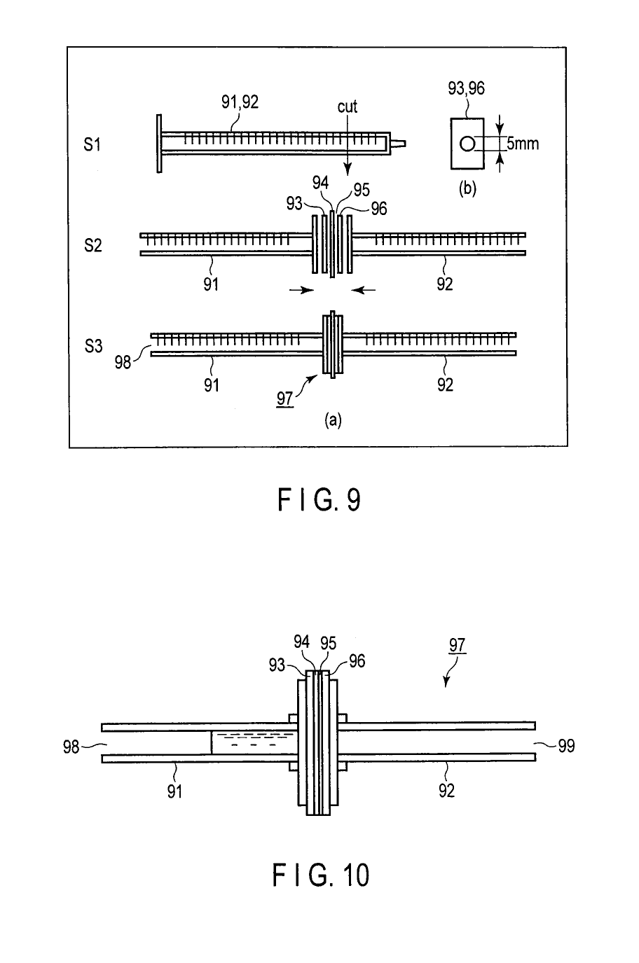

Referring to FIG. 9A, production of an apparatus for a syringe test apparatus is explained. First, two 1-mL disposable resin syringes 91 and 92 for tuberculin were prepared. A tip of a side at which a needle was set of each of these resin syringes 91 and 92 were cut off (S1). The obtained two cut syringes 91 and 92 were made to face to each other at the grip parts thereof, and two rubber pieces and a pair of desalination treatment membranes were sandwiched between them. A first syringe 91, a first rubber piece 93, a base material to which functional group were bonded (modified base material) 94, a desalting membrane 95, a second rubber piece 96, and a second syringe 92 were sandwiched in this order, and it was fixed with a clip (not shown in the drawing) (S2). Here, the modified base material was disposed in close contact with the active layer side of the desalting membrane.

The apparatus for the syringe test 97 was obtained as described above (S3). An RO membrane, ES 20, manufactured by Nitto Denko Corporation, was used as the desalting membrane 55. Each of Example 3, Example 4 and Example 5 was used as the modified base material 94. As the first and the second rubber pieces 93 and 96, a rubber plate was used, and each rubber piece was bored to form a circular hole with a diameter of 5 mm therein, as shown in FIG. 9B.

### (2) Syringe Test

As shown in FIG. 10, 0.5 mL of pure water was injected into the first syringe from an opening 98 of the first syringe 91 in the apparatus for the syringe test 97 produced in (1) described above. Further, 0.5 mL of pure water was injected into the second syringe from an opening 99 of the second syringe 92. The injection of the pure water from any opening was performed until the water reached the desalting membrane 95. The apparatus was allowed to stand for 15 hours, and the movement of the water from the first syringe 91 to the second syringe 92, which had occurred during the 15 hours, was observed. The results are shown as the amount moved, obtained by measuring a volume (mL) of water which had moved. For comparison, the same experiment as above was performed except that a blank in which the modified base material was not disposed and the desalting membrane was disposed was used.

### (3) Results

The results are shown in Table 1.

TABLE 1

| | Modified base | | |
|---|---|---|---|
| Desalting | material to | Movement of water | Movement of water |
| membrane | be tested | in first syringe | in second syringe |
| ES20 | Blank (no | −0.01 ml | 0.00 ml |
| | base material) | | |
| ES20 | Example 3 | −0.04 ml | 0.04 ml |
| ES20 | Example 4 | −0.07 ml | 0.06 ml |
| ES20 | Example 5 | −0.13 ml | 0.12 ml |

As shown in Table 1, in the apparatus for the syringe test 97, when Example 3, 4 or 5 was disposed, water injected into the first syringe moved to the second syringe. From this result, the functional groups, which had been introduced into the base material by the silane coupling reaction, could force the water in the first syringe into the second syringe. It can be considered that it occurred because the functional groups on the modified base material induced an osmotic pressure.

### <High Pressure Test>

### (1) Apparatus for High Pressure Test

A high pressure test was performed for Examples 1 and 2, which were obtained according to the method described in Case 1.

A high pressure test was performed using the base material to which the solid salt was grafted which was produced (1) above.

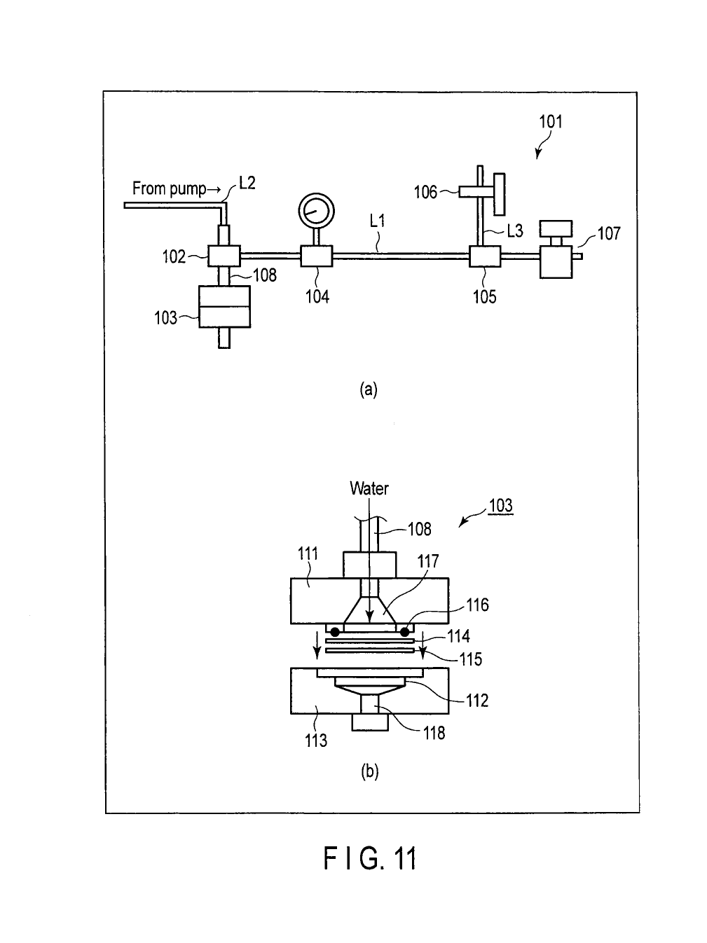

The high pressure test was performed as shown in FIG. 11 (a). A test apparatus 101 includes a main first pipe L1. A first connector 102 is attached to a left end of the first pipe L1. A cell 103 is connected to the first connector 102 through an introduction pipe 108. A second pipe L2, to which a pump is attached at one end (not shown) is connected to the introduction pipe 108. A second connector 105 is attached to a vicinity of a right end of the first pipe L1. A pressure gauge 104 is attached to the first pipe L1 between the first and second connectors 102 and 105. A third pipe L3 is connected to the second connector 105, and a first pressure-releasing valve 106 is attached to the third pipe L3. A second pressure-releasing valve 107 is attached to the first pipe L1 on the right end from the second connector 105.

The structure of the cell 103 is shown in FIG. 11 (b). The cell 103 includes a first support member 111, and a second support member 113, which is arranged below facing the first support member 41. The first support member 111 is formed so that a flow channel 117, into which the introduction pipe 108 in FIG. 11 (a) is communicated, penetrates it up and down. An O-ring 116, which plays a role as a gasket, is attached to an undersurface of the first support member 111 so as to surround an opening of the flow channel 117. The second support member 113 is formed so that a perforated plate 112 and a flow channel 118 penetrate it up and down from the upper side. A desalting membrane 115 and a filter paper 114 are arranged on the perforated plate 112 of the second support member 113 in this order. The desalting membrane 115 and the filter paper 114 are arranged between the flow channel 117 in the first support member 111 and the flow channel 118 in the second support member 113 by abutting an undersurface of the first support member 111 against an upper surface of the second support member 113 in this state and fixing them. Water, flowing in the flow channel 117 of the first support member 111, passes through the desalting membrane 115 and the filter paper 116, and flows in the perforated plate 112, and then is discharged from an outlet, which opens from a bottom of the flow channel 118 toward the outside of the second support member 113, thereby measuring a quantity of flow. In a blank test, the filter paper was not arranged in the cell.

As shown in FIGS. 11A and 11B, in the experiments, pure water was poured into the cell 103 of the test apparatus 101 from the pump, and the pump, the first pressure-relief valve 106 and the second pressure-relief valve 107 were controlled so that the osmotic pressure was 1 MPa. An RO membrane, ES 20, manufactured by Nitto Denko Corporation, was used as the osmosis membrane. Example 1 or 2 was used as the modified base material. The experiments were all performed at 20 degrees Celsius by an aluminum jacket surrounding the high pressure cell, passing water controlled the temperature with thermostatic bath, and the pure water was poured for 5 minutes. A weight of water which passed through the desalination treatment membrane and dripped to the perforated plate over 5 minutes was measured in the amount of water which had flowed. The measured value was expressed in grams as the amount of water which had flowed.

The results are described in table 2.

TABLE 2

| Desalting | Modified base | Amount |
|---|---|---|
| membrane | material to be tested | flowed (g) |
| ES20 | Blank | 0.9 |
| ES20 | Example 1 | 1.1 |
| ES20 | Example 2 | 1.2 |
| ES20 | Example 2 | 1.3 |
| ES20 | Example 2 | 1.2 |
| ES20 | Blank | 1 |

As shown in table 2, when Examples 1 and 2 were used, more water passed through the desalination treatment membrane and moved compared to the blank test. It can be considered that it occurred because the functional groups on the modified base material induced an osmotic pressure.

### Case 2

### <Modification of Base Material Using Glutaraldehyde>

### (Synthesis Method)

### 1. Glutaraldehyde

Using glutaraldehyde as a cross-linking agent, polyethylene imine, pentaethylene hexamine and tris(2-aminoethyl)amine were cross-linked. The resulting polymer was bonded to a filter paper, which was a base material.

### (1) Polyethylene Imine

A filter paper for Kiriyama-rohto was immersed in a 5% polyethylene imine solution for one hour. After one hour, the filter paper was taken out therefrom and dried. After that, the obtained filter paper was immersed in a 10% glutaraldehyde solution. The immersion was performed for one hour while ultrasonic waves were applied thereto. The obtained filter paper was taken out therefrom, and it was immersed in 5% hydrochloric acid for 5 minutes. After that, it was thoroughly washed with pure water to obtain a polyethylene-modified filter paper, which was used as Example 6.

### (2) Pentaethylene Hexamine

A filter paper for Kiriyama-rohto was immersed in a 5% pentaethylene hexamine solution for one hour. After one hour, the filter paper was taken out therefrom and dried. After that, the obtained filter paper was immersed in a 10% glutaraldehyde solution. The immersion was performed for one hour while ultrasonic waves were applied thereto. The obtained filter paper was taken out therefrom, and it was immersed in 5% hydrochloric acid for 5 minutes. After that, it was thoroughly washed with pure water to obtain a pentaethylene hexamine-modified filter paper, which was used as Example 7.

(3) Tris(2-aminoethyl)amine

A filter paper for Kiriyama-rohto was immersed in a 5% tris(2-aminoethyl)amine solution for one hour. After one hour, the filter paper was taken out therefrom and dried. After that, the obtained filter paper was immersed in a 10% glutaraldehyde solution. The immersion was performed for one hour while ultrasonic waves were applied thereto. The obtained filter paper was taken out therefrom, and it was immersed in 5% hydrochloric acid for 5 minutes. After that, it was thoroughly washed with pure water to obtain a tris(2-aminoethyl)amine-modified filter paper, which was used as Example 8.

### 2. Formaldehyde

Using formaldehyde as a cross-linking agent, polyethylene imine was cross-linked. The resulting polymer was bonded to a filter paper, which was a base material.

A filter paper for Kiriyama-rohto was immersed in a 5% polyethylene imine solution for one hour. After one hour, the filter paper was taken out there from and dried. After that, the obtained filter paper was immersed in a 35% formaldehyde solution. The immersion was performed at 50° C. for one hour. The obtained filter paper was taken out there from, and it was immersed in 5% hydrochloric acid for 5 minutes. After that, it was thoroughly washed with pure water to obtain a polyethylene-modified filter paper, which was used as Example 8.

### <High Pressure Test>

The high pressure test was performed for Examples 6 to 9, obtained by the methods described in <Synthesis Method> above.

As shown in FIGS. 11A and 11B of an apparatus for high pressure test described above, in the experiments, pure water was poured into the cell 103 of the test apparatus 101 from the pump, and the pump, the first pressure-relief valve 106 and the second pressure-relief valve 107 were controlled so that the osmotic pressure was 1 MPa. An RO membrane, ES 20, manufactured by Nitto Denko Corporation, was used as the osmosis membrane. Each of Examples 6 to 9 was used as the modified base material. The experiments were all performed at 30 degrees Celsius by an aluminum jacket surrounding the high pressure cell, passing water controlled the temperature with thermostatic bath, and the pure water was poured for 5 minutes. A weight of water which passed through the desalination treatment membrane and dripped to the perforated plate over 5 minutes was measured to obtain an amount of water which had flowed. For comparison, the same experiment as above was performed except that a non-modified filter paper was disposed in contact with the desalting membrane.

The results are described in Table 3.

TABLE 3

| | Cross-linking | | Amount |
|---|---|---|---|
| | agent | Amine | flowed (g) |
| | — | — | 1.52 |
| Example 6 | Glutaraldehyde | Polyethylene imine | 1.63 |
| Example 7 | Glutaraldehyde | Pentaethylene hexamine | 1.60 |
| Example 8 | Glutaraldehyde | Tris(2- | 1.59 |
| | | aminoethyl)amine | |
| Example 9 | Formaldehyde | Polyethylene imine | 1.61 |

As shown in Table 3, when Examples 6 to 9 were used, more water passed through the desalination treatment membrane and moved compared to the blank test. It can be considered that it occurred because the functional groups on the modified base material induced an osmotic pressure.

### <Syringe Test>

Referring to FIG. 9A, production of an apparatus for a syringe test is explained. First, two 1-mL disposable resin syringes 91 and 92 for tuberculin were prepared. A tip of a side at which a needle was set of each of these resin syringes 91 and 92 were cut off (S1). The obtained two cut syringes 91 and 92 were made to face to each other at the grip parts thereof, and two rubber pieces and a pair of desalination treatment membranes were sandwiched between them. A first syringe 91, a first rubber piece 93, a base material to which functional group were bonded (modified base material) 94, a desalting membrane 95, a second rubber piece 96, and a second syringe 92 were sandwiched in this order, and it was fixed with a clip (not shown in the drawing) (S2). Here, the modified base material was disposed in close contact with the active layer side of the desalting membrane.

The apparatus for the syringe test 97 was obtained as described above (S3). An RO membrane, ES 20, manufactured by Nitto Denko Corporation, was used as the desalting membrane 55. Example 6 was used as the modified base material 94. As the first and the second rubber pieces 93 and 96, a rubber plate was used, and each rubber piece was bored to form a circular hole with a diameter of 5 mm therein, as shown in FIG. 9B.

In this apparatus for the syringe test, the modified base material of Example 6 (the reaction product of polyethylene imine and glutaraldehyde) was used as the modified base material. The modified base material was stuck to the active layer side of the desalting membrane with an adhesive.

Next, as shown in FIG. 10, 0.5 mL of pure water was injected into the first syringe from an opening 98 of the first syringe 91. Further, 0.5 mL of pure water was injected into the second syringe from an opening 99 of the second syringe 92. The injection of the pure water from any opening was performed until the water reached the desalting membrane 95. The apparatus was allowed to stand for 24 hours, and the movement of the water from the first syringe 91 to the second syringe 92, which had occurred during the 24 hours, was observed. For comparison, the same experiment as above was performed except that a blank in which the modified base material was not disposed and the desalting membrane was disposed was used. The results are shown as the amount moved, obtained by measuring a volume (mL) of water which had moved.

The results are shown in Table 4.

TABLE 4

| | | Amount of water |
|---|---|---|
| | | which had moved (ml) |
| Blank | — | 0 |
| Example 6 | PEI + GA | 0.008 |

As apparent from Table 4, Example 6 could move more water to the second syringe from the first syringe compared to the blank. It can be considered that it occurred because the functional groups on the modified base material induced an osmotic pressure.

### Case 3

<Study about Kind of Counter Ion to Polyethylene Imine>

Effects in the osmotic pressure induced by the polyethylene imine on the kind of an anion were studied. The polyethylene imine serves as a cation because positive ions are included therein. It was studied that when the polyethylene imine served as the cation, whether or not the osmotic pressure induced by the polyethylene imine was influenced depending on the kind of the counter ion thereof.

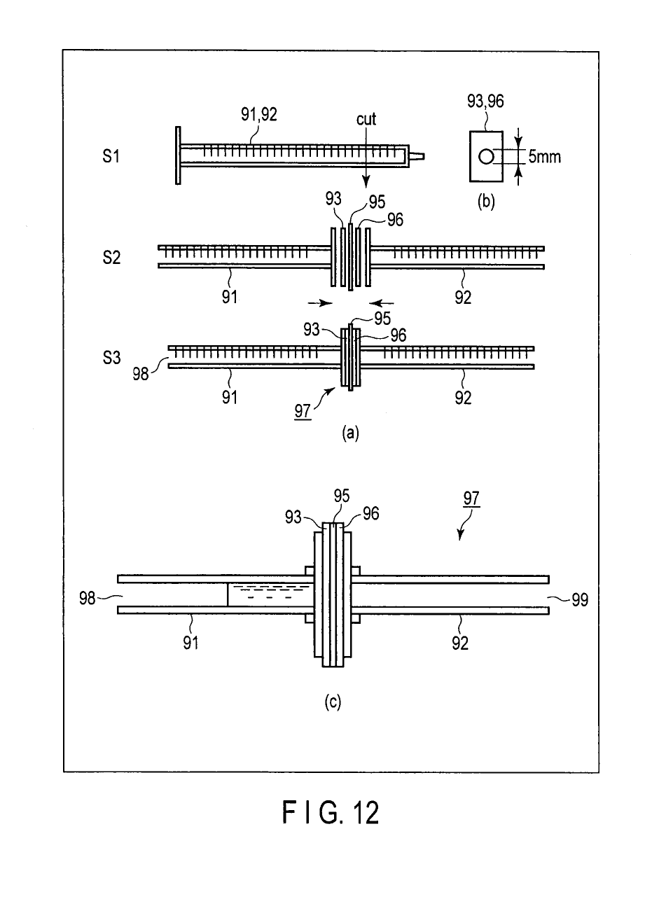

Referring to FIG. 12A, production of an apparatus for a syringe test is explained. First, two 1-mL disposable resin syringes 91 and 92 for tuberculin were prepared. A tip of a side at which a needle was set of each of these resin syringes 91 and 92 were cut off (S1). The obtained two cut syringes 91 and 92 were made to face to each other at the grip parts thereof, and two rubber pieces and a pair of desalting membranes were sandwiched between them. A first syringe 91, a first rubber piece 93, a desalting membrane 95, a second rubber piece 96, and a second syringe 92 were sandwiched in this order, and it was fixed with a clip (not shown in the drawing) (S2).

The apparatus for the syringe test 97 was obtained as described above (S3). An RO membrane, ES 20, manufactured by Nitto Denko Corporation, was used as the desalting membrane 55. An active layer side of this ES 20 was disposed so that it faced to the inside of the second syringe, and a support layer of the ES 20 was disposed so that it faced to the inside of the first syringe. As the first and the second rubber pieces 93 and 96, a rubber plate was used, and each rubber piece was bored to form a circular hole with a diameter of 5 mm therein, as shown in FIG. 12B.

Using this apparatus for the syringe test, the effects given by the kind of the anion coexisting on the osmotic pressure induced by the polyethylene imine were studied as follows:

As shown in FIG. 12C, 0.5 mL of 1% aqueous NaCl solution, or 0.5 mL of 3.5% aqueous NaCl solution was injected into the first syringe 91 from an opening 98 of the first syringe. 0.5 mL of a mixed liquid including 5% by weight of polyethylene imine and 5% by weight of an acid in pure water was injected into the second syringe 92 from an opening 99 of the second syringe. The acid used was hydrochloric acid, trifluorosulfonic acid, sulfuric acid, or phosphoric acid. Tests about one kind of a counter anion using these acids were performed. For comparison, the same experiment was performed except that the acid was not added, and only 5% by weight of polyethylene imine was injected to the second syringe.

After that, the apparatus was allowed to stand for 4 hours, and an amount of water moving from the first syringe 91 to the second syringe 92, which had occurred during the 4 hours, was observed, and expressed as the amount moved.

The results are shown in Table 5.

TABLE 5

Amount of water
which had moved (ml)

| Kind of anion | 1% NaCl aq. | 3.5% NaCl aq. |
|---|---|---|
| Cl⁻ | 0.05 | 0.02 |
| CF₃SO₃⁻ | 0.02 | 0.00 |
| SO₄²⁻ | 0.00 | −0.02 |
| PO₄³⁻ | −0.03 | −0.04 |
| None | −0.03 | −0.03 |

As apparent from Table 5, when the chlorine ion existed as an anion, which was a counter ion, more water moved from the first syringe to the second syringe compared to the case in which polyethylene imine existed alone. It became apparent, therefore, that in the state in which the polyethylene imine existed as the cation and the chlorine ion existed as the anion, a higher osmotic pressure was induced on the desalting membrane from the salt water side to the fresh water side.

### Case 4

<Study about Effects on Osmotic Pressure by Anion Exchange Resin>

Using an ion exchange resin as a modified base material, a syringe test was performed.

As the ion exchange resin, amberlite was used. The amberlite was pulverized in an agate mortar into a size with an average diameter of about 1 μm to 10 μm. Using the thus pulverized amberlite, a syringe test was performed.

Referring to FIG. 12A, production of an apparatus for a syringe test apparatus is explained. First, two 1-mL disposable resin syringes 91 and 92 for tuberculin were prepared. A tip of a side at which a needle was set of each of these resin syringes 91 and 92 were cut off (S1). The obtained two cut syringes 91 and 92 were made to face to each other at the grip parts thereof, and two rubber pieces and a pair of desalting membranes were sandwiched between them. A first syringe 91, a first rubber piece 93, a desalting membrane 95, a second rubber piece 96, and a second syringe 92 were sandwiched in this order, and it was fixed with a clip (not shown in the drawing) (S2).

The apparatus for the syringe test 97 was obtained as described above (S3). An RO membrane, ES 20, manufactured by Nitta Denko Corporation, was used as the desalting membrane 55. An active layer side of this ES 20 was disposed so that it faced to the inside of the second syringe, and a support layer of the ES 20 was disposed so that it faced to the inside of the first syringe. As the first and the second rubber pieces 93 and 96, a rubber plate was used, and each rubber piece was bored to form a circular hole with a diameter of 5 mm therein, as shown in FIG. 12B.

Using this apparatus for the syringe test, the effects given by the amberlite on the osmotic pressure were studied as follows:

As shown in FIG. 12C, 0.5 mL of pure water was injected into the first syringe 91 from an opening 98 of the first syringe. 0.5 mL of a suspension including 5% by weight of the pulverized amberlite in pure water was injected into the second syringe 92 from an opening 99 of the second syringe.

After that, the apparatus was allowed to stand for 24 hours, and an amount of water moving from the first syringe 91 to the second syringe 92, which had occurred during the 24 hours, was observed, and expressed as an amount moved.

Separately, an apparatus for the syringe test which was the same as that shown in FIG. 12A except that the amberlite was disposed between the desalting membrane 95 and the second rubber pieces 96, was produced. 0.5 mL of pure water was injected into the first syringe 91 from an opening 98 of the first syringe. 0.5 mL of pure water was injected into the second syringe 92 from an opening 99 of the second syringe. After that, the apparatus was allowed to stand for 24 hours, and an amount of water moving from the first syringe 91 to the second syringe 92, which had occurred during the 24 hours, was observed. The results are shown as the amount moved, obtained by measuring a volume (mL) of water which had moved.

The results are shown in Table 6.

TABLE 6

| Desalting | Modified base | Movement of water | Movement of water |
|---|---|---|---|
| membrane | material | in first syringe | in second syringe |
| ES20 | Fresh water + | 0.10 ml/ | 0.01 ml/ |
| | Amberlite | 24 h decrease | 24 h increase |
| ES20 | Fresh water + | 0.06 ml/ | 0.026 ml/ |
| | Amberlite powder | 24 h decrease | 24 h increase |

As apparent from Table 6, the movement of water from the first syringe to the second syringe was observed in either the case in which the amberlite was disposed or the case in which the pulverized amberlite (amberlite powder) was disposed. From this result, the ion exchange resin can also be used as the modified base material.

### Case 5

### <Effects on Osmotic Pressure by Ion Exchange Filter Paper>

### 1. High Pressure Test

Using an ion exchange filter paper as a modified base material, a high pressure test was performed.

As shown in FIGS. 11A and 11B of the apparatus for high pressure test described above, in the experiments, pure water was poured into the cell 103 of the test apparatus 101 from the pump, and the pump, the first pressure-relief valve 106 and the second pressure-relief valve 107 were controlled so that the osmotic pressure was 1 MPa. An RO membrane, ES 20, manufactured by Nitto Denko Corporation, was used as the osmosis membrane. F-SC10 (a cation exchange filter paper manufactured by NITIVY Co., Ltd) or F-SA10 (an anion exchange filter paper manufactured by NITIVY Co., Ltd) was used as the modified base material.

The experiments were performed at 30° C. at a liquid sending speed of 2 mL/minute. A weight of water which passed through the desalination treatment membrane and dripped to the perforated plate was measured while the pure water was poured for 5 minutes to obtain an amount of water which had flowed. For comparison, the same test was performed using an apparatus for high pressure test in which the modified base material was not disposed and the ES 20 was disposed alone.

As a result, when the F-SC10 was disposed as the modified base material, the amount of water which had flowed was increased by 16% compared to the blank case in which ES 20 was disposed alone. The F-SC 10 used was a filter paper with a thickness of 1 mm or thicker, which was thicker than that of an average filter paper. About 45% of this thickness was shaved with a sandpaper, and the same experiment was performed. In this case, an amount of water which had flowed was increased by 14%. From this result, it was found that, in the case of F-SC 10, the thickness of the F-SC 10 did not influence a rate of increase in the amount of water which had flowed through the F-SC 10 to the blank.

Separately, an apparatus for high pressure test was produced which was the same apparatus as above except that F-SA10 (an anion exchange filter paper manufactured by NITIVY Co., Ltd.) was used as a modified base material. Using this apparatus, the same high pressure test as above was performed.

As a result, when using the F-SA 10, the amount of water which had flowed was decreased by 6% compared to the blank. When using the F-SA10 whose thickness was shaved with the sandpaper by 40%, the same test was performed; however, the amount of water which had flowed was increased by 6% compared to the blank. From the result, it was found that, in the case of the F-SA 10, the thickness of the F-SA 10 influenced a rate of increase in the amount of water which had flowed through the F-SA 10 to the blank.

Furthermore, separately, an apparatus for high pressure test was produced which was the same apparatus as above except that DE 81 (Wattmann, an anion exchange filter paper) was used as a modified base material. Using this apparatus, the same high pressure test as above was performed.

As a result, in the case of DE 81, the amount of water which had flowed was increased by 1% compared to the blank. DE 81 was a filter paper which was thinner than that of the filter paper above. Next, an apparatus for high pressure test in which three DE 81 papers were overlapped, which was disposed in close contact with the desalting membrane was produced. Using the apparatus, the high pressure test was performed. The amount of water which had flowed was decreased by 10% compared to the blank.

From these results, it could be considered that the pressure loss occurred by the base material, for example, the filter paper, was a factor which greatly influenced on the amount of fresh water obtained by the desalination treatment membrane.

### 2. Syringe Test

Referring to FIG. 9A, production of an apparatus for a syringe test is explained. First, two 1-mL disposable resin syringes 91 and 92 for tuberculin were prepared. A tip of a side at which a needle was set of each of these resin syringes 91 and 92 were cut off (S1). The obtained two cut syringes 91 and 92 were made to face to each other at the grip parts thereof, and two rubber pieces and a pair of desalination treatment membranes were sandwiched between them. A first syringe 91, a first rubber piece 93, a modified base material 94, a desalting membrane 95, a second rubber piece 96, and a second syringe 92 were sandwiched in this order, and it was fixed with a clip (not shown in the drawing) (S2). Here, the modified base material was disposed in close contact with the active layer side of the desalting membrane.

The apparatus for a syringe test 97 was obtained as described above (S3). An RO membrane, ES 20, manufactured by Nitto Denko Corporation, was used as the desalting membrane 55. The F-SC 10 which is an ion exchange filter paper (a cation exchange filter paper manufactured by NITIVY Co., Ltd.) was used as the modified base material 94. As the first and the second rubber pieces 93 and 96, a rubber plate was used, and each rubber piece was bored to form a circular hole with a diameter of 5 mm therein, as shown in FIG. 9B.

### (2) Syringe Test

As shown in FIG. 10, 0.5 mL of pure water was injected into the first syringe from an opening 98 of the first syringe 91 in the apparatus for the syringe test 97 produced in (1) described above. Further, 0.5 mL of pure water was injected into the second syringe from an opening 99 of the second syringe 92. The injection of the pure water from any opening was performed until the water reached the desalting membrane 95. The apparatus was allowed to stand horizontally at 30° C. for 15 hours, and the movement of the water from the first syringe 91 to the second syringe 92, which had occurred during the 15 hours, was observed. The results are shown as the amount moved, obtained by measuring a volume (mL) of water which had moved.

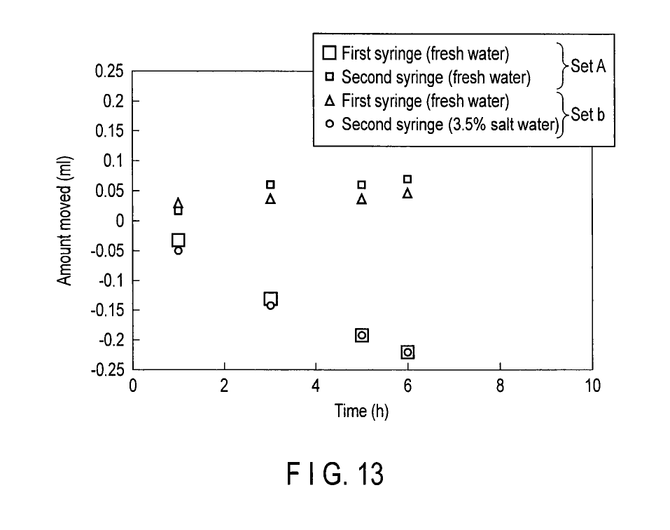

The results of the syringe tests are shown in FIG. 13 as Set A. As apparent from FIG. 13, the liquid amount in the first syringe (shown by a big square in FIG. 13) was decreased, and the liquid amount in the second syringe (shown by a small square in FIG. 13) was increased. At that time, the F-SC 10 used as the modified base material was a 6 mm×6 mm square filter paper.

A different syringe test was performed. In such a test, the same test as above was performed except that 0.5 mL of salt water in which 3.5% of NaCl was dissolved in water was injected into the second syringe. At that time, the F-SC 10 used as the modified base material was a 5 mmφ filter paper.

The results of the syringe tests are shown in FIG. 13 as Set B. As apparent from FIG. 13, the liquid amount in the first syringe (shown as a circle in FIG. 13) was increased, and the liquid amount in the second syringe (shown as a triangle in FIG. 13) was decreased.

From these results, it became apparent that the ion exchange filter paper could be used as the modified base material.

When the functional groups are disposed in the vicinity of the desalting membrane, it is possible to induce an osmotic pressure toward the desalination treatment membrane including the desalting membrane, whereby it is possible to obtain more amount of fresh water from salt water than that conventionally obtained. It is possible, therefore, to obtain fresh water from seawater at lower energy than that conventionally obtained.

### Case 6

<Modification of Base material Using Cationic Polymer>

A filter paper was modified with a cationic polymer as described below to produce Examples 10 to 13.

### (Synthesis Method)

### 1-(1) Tetrakis(bromomethyl)Benzene

Using tetrakis(bromomethyl)benzene as a cross-linking agent, polyethylene imine was cross-linked. The resulting polymer was bonded to a filter paper, which was a base material.

Specifically, 0.5 g of tetrakis(bromomethyl)benzene was dissolved in 20 mL of acetone, and a filter paper for Kiriyama-rohto was immersed in the solution, to which 10 mL of a 10% aqueous sodium hydroxide solution was added. After stirring was performed at 50° C. for 5 hours, the filter paper was taken out therefrom. The obtained filter paper was washed with pure water and acetone. After that, the filter paper was added to 1 g of polyethylene imine dissolved in 20 mL of acetone, and the reaction was performed at 50° C. for 6 hours. After the reaction, the filter paper was taken out therefrom, and the obtained filter paper was washed with pure water. The filter paper was immersed in 5% hydrochloric acid for 10 minutes. After that, the filter paper was thoroughly washed with pure water to obtain a filter paper to which tetrakis(bromomethyl)benzene-fixed polyethylene imine was bonded, which was used as Example 10.

### 1-(2) Tetrakis(bromomethyl)benzene

Using tetrakis(bromomethyl)benzene as a cross-linking agent, tris(2-aminoethyl)amine was cross-linked. The resulting polymer was bonded to a filter paper, which was a base material.

Specifically, 0.5 g of tetrakis(bromomethyl)benzene was dissolved in 20 mL of acetone 20 mL, and a filter paper for Kiriyama-rohto was immersed in the solution, to which a 10% aqueous sodium hydroxide solution was added. After stirring was performed at 50° C. for 5 hours, the filter paper was taken out therefrom. The obtained filter paper was washed with pure water and acetone. After that, the filter paper was added to 1 g of tris(2-aminoethyl)amine dissolved in 20 mL of acetone, and the reaction was performed at 50° C. for 6 hours. After the reaction, the filter paper was taken out therefrom, and the obtained filter paper was washed with pure water. The filter paper was immersed in 5% hydrochloric acid for 10 minutes. The filter paper was thoroughly washed with pure water to obtain a filter paper to which tetrakis(bromomethyl)benzene-fixed tris(2-aminoethyl)amine was bonded, which was used as Example 11.

### 2-(1) Tetrakis(bromomethyl)methane

Using tetrakis(bromomethyl)methane as a cross-linking agent, polyethylene imine was cross-linked. The resulting polymer was bonded to a filter paper, which was a base material.

Specifically, 0.5 g of tetrakis(bromomethyl)methane was dissolved in 20 mL of acetone 20 mL, and a filter paper for Kiriyama-rohto was immersed in the solution, to which 10 mL of a 10% aqueous sodium hydroxide solution was added. After stirring was performed at 50° C. for 5 hours, the filter paper was taken out therefrom. The obtained filter paper was washed with pure water and acetone. After that, the filter paper was added to 1 g of polyethylene imine dissolved in 20 mL of acetone, and the reaction was performed at 50° C. for 6 hours. After the reaction, the filter paper was taken out therefrom, and the obtained filter paper was washed with pure water. The filter paper was immersed in 5% hydrochloric acid for 10 minutes. The filter paper was thoroughly washed with pure water to obtain a filter paper to which tetrakis(bromomethyl)methane-fixed polyethylene imine was bonded, which was used as Example 12.

### 2-(2) Tetrakis(bromomethyl)methane

Using tetrakis(bromomethyl)methane as a cross-linking agent, tris(2-aminoethyl)amine was cross-linked. The resulting polymer was bonded to a filter paper, which was a base material.

Specifically, 0.5 g of tetrakis(bromomethyl)methane was dissolved in 20 mL of acetone, and a filter paper for Kiriyama-rohto was immersed in the solution, to which 10 mL of a 10% aqueous sodium hydroxide solution was added. After stirring was performed at 50° C. for 5 hours, the filter paper was taken out therefrom. The obtained filter paper was washed with pure water and acetone. After that, the filter paper was added to 1 g of tris(2-aminoethyl)amine dissolved in 20 mL of acetone, and the reaction was performed at 50° C. for 6 hours. After the reaction, the filter paper was taken out therefrom, and the obtained filter paper was washed with pure water. The filter paper was immersed in 5% hydrochloric acid for 10 minutes. The filter paper was thoroughly washed with pure water to obtain a filter paper to which tetrakis(bromomethyl)methane-fixed tris(2-aminoethyl)amine was bonded, which was used as Example 13.

### <High Pressure Test>

### (1) Apparatus for High Pressure Test

A high pressure test was performed for Examples 10 to 13, which were obtained according to the method described in Case 6.

As shown in FIGS. 11A and 11B of the apparatus for high pressure test described above, in the experiments, pure water was poured into the cell 103 of the test apparatus 101 from the pump, and the pump, the first pressure-relief valve 106 and the second pressure-relief valve 107 were controlled so that the osmotic pressure was 1 MPa. An RO membrane, ES 20, manufactured by Nitto Denko Corporation, was used as the osmosis membrane. Each of Examples 10 to 13 was used as the modified base material. The experiments were all performed at 30 degrees Celsius by an aluminum jacket surrounding the high pressure cell, passing water controlled the temperature with thermostatic bath, and the pure water was poured for 5 minutes. A weight of water which passed through the desalination treatment membrane and dripped to the perforated plate over 5 minutes was measured in the amount of water which had flowed. The measured value was expressed in grams as the amount of water which had flowed.

The results are described in Table 7.

TABLE 7

| | Cross-linking | | Amount |
|---|---|---|---|
| | agent | Amine | flowed (g) |
| | — | — | 1.52 |
| Example 10 | Tetrakis(bromo- | Polyethylene imine | 1.58 |
| | methyl)benzene | | |
| Example 11 | Tetrakis(bromo- | Tris(2- | 1.59 |
| | methyl)benzene | aminoethyl)amine | |
| Example 12 | Tetrakis(bromo- | Polyethylene imine | 1.60 |
| | methyl)methane | | |
| Example 13 | Tetrakis(bromo- | Tris(2- | 1.60 |
| | methyl)methane | aminoethyl)amine | |

As shown in Table 7, when Examples 10 to 13 were used, more water passed through the desalination treatment membrane and moved compared to the blank test. It can be considered that it was occurred because the functional groups on the modified base material induced an osmotic pressure.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A desalination treatment membrane comprising a desalting membrane and a base material disposed in close contact with the desalting membrane, the base material being subjected to a silane coupling treatment.

2. The desalination treatment membrane of claim 1, wherein the base material comprises a cellulose or a fabric.

3. The desalination treatment membrane of claim 2, comprising the cellulose, wherein the cellulose is a paper.

4. The desalination treatment membrane of claim 1, wherein the base material comprises:
an aminosilane having a structure comprising a formula H2NCH2CH2NHCH2CH2CH2Si as a part of the structure, the aminosilane being in a state of an ammonium salt, and
an anion as a counter ion of the ammonium salt.

5. A desalination treatment apparatus comprising:
a sealing treatment vessel;
the desalination treatment membrane of claim 1, which divides the treatment vessel into a first chamber and a second chamber;
a first inlet provided on a first portion of the treatment vessel at which the first chamber is located;
a second inlet provided on a second portion of the treatment vessel at which the second chamber is located;
an outlet provided on a third portion of the treatment vessel at which the second chamber is located;
salt water received in the first chamber passed through the first inlet; and
fresh water received in the second chamber passed through the second inlet,
wherein the desalting membrane in the desalination treatment membrane is disposed at a side of the first chamber in which the salt water is housed.

6. A desalination treatment membrane comprising a desalting membrane and a base material disposed in close contact with the desalting membrane, the base material comprising a functional group comprising a group of a formula (II) or (III): 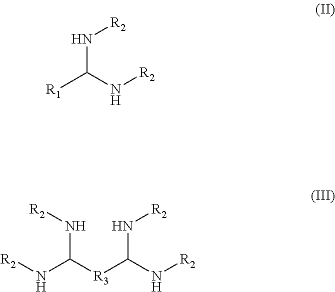
wherein R1 is H or an alkyl group having 5 or fewer carbon atoms;
R2 is a polyamine or a polyethylene imine; and
R3 is an alkyl group having 5 or fewer carbon atoms.

7. The desalination treatment membrane of claim 6, wherein the functional group is obtained by reacting a dialdehyde compound with a compound having 2 or more amino groups.

8. The desalination treatment membrane of claim 6, wherein the functional group is obtained by reacting formaldehyde with a compound having 2 or more amino groups.

9. A desalination treatment apparatus comprising:
a sealing treatment vessel;
the desalination treatment membrane of claim 6, which divides the treatment vessel into a first chamber and a second chamber;
a first inlet provided on a first portion of the treatment vessel at which the first chamber is located;
a second inlet provided on a second portion of the treatment vessel at which the second chamber is located;
an outlet provided on a third portion the treatment vessel at which the second chamber is located;
salt water received in the first chamber passed through the first inlet; and
fresh water received in the second chamber passed through the second inlet
wherein a surface of the desalination treatment membrane on which the functional group is carried is located on a side of the second chamber in which the fresh water is received.

10. A desalination treatment apparatus comprising:
a sealing treatment vessel;
a desalting membrane that divides the treatment vessel into a first chamber and a second chamber;
a base material disposed in a vicinity of a side of the second chamber in the desalting membrane and carrying a functional group comprising an amino group in a state of a salt;
a first inlet provided on a first portion of the treatment vessel at which the first chamber is located;
a second inlet provided on a second portion of the treatment vessel at which the second chamber is located;
an outlet provided on a third portion of the treatment vessel at which the second chamber is located;
salt water received in the first chamber passed through the first inlet; and
fresh water received in the second chamber passed through the second inlet.

11. The desalination treatment apparatus of claim 10, wherein a cation of the functional group comprising the amino group in the state of a salt is a cationic polyethylene imine.

12. The desalination treatment apparatus of claim 11, wherein a counter ion in the state of a salt is a chlorine ion.

13. The desalination treatment apparatus of claim 10, wherein the base material is a silica particle.

14. A desalination treatment method comprising:
removing water from salt water by contacting the salt water with a desalination treatment membrane comprising a desalting membrane, a base material disposed in close contact with the desalting membrane, the base material being selected from the group consisting of an ion exchange resin, a pulverized product thereof, and a ion exchange filter paper,
wherein the desalting membrane in the desalination treatment membrane is disposed on a side of the salt water, and the base material is disposed on a side of fresh water.

15. A desalination treatment membrane comprising a desalting membrane and a base material disposed in close contact with the desalting membrane, the base material comprising a functional group having a structure unit represented by a formula (XI): 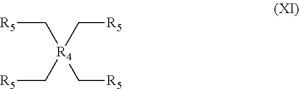
wherein R4 is an alkylene group or an aromatic group; and
R5 is a polyamine, a halogen or a polymer forming a carrier.

16. The desalination treatment membrane of claim 15, wherein the functional group is obtained by reacting a polyamine with a halogenated alkyl group-comprising crosslinking agent.

17. A desalination treatment apparatus comprising:
a sealing treatment vessel;
the desalination treatment membrane of claim 15, which divides the treatment vessel into a first chamber and a second chamber;
a first inlet provided on a first portion of the treatment vessel at which the first chamber is located;
a second inlet provided on a second portion of the treatment vessel at which the second chamber is located;
an outlet provided on the a third portion of treatment vessel at which the second chamber is located;
salt water received in the first chamber passed through the first inlet; and
fresh water received in the second chamber passed through the second inlet,
wherein a surface of the desalination treatment membrane on which the functional group is carried is disposed on a side of the second chamber in which the fresh water is received.
